(19) United States
(12) Patent Application Publication
(10) Pub. No.: US 2016/0026997 A1
(43) Pub. Date: Jan. 28, 2016

(54) Mobile Communication Device with Proximity Based Communication Circuitry

(71) Applicant: XPressTap, Inc., Los Altos, CA (US)

(72) Inventors: William Tsui, Burnaby (CA); Elaine Law, Burnaby (CA); Erick Lee, Burnaby (CA); Joe M. Lynam, Los Altos, CA (US); Mark E. Snycerski, San Jose, CA (US)

(21) Appl. No.: 14/809,162

(22) Filed: Jul. 24, 2015

Related U.S. Application Data
(60) Provisional application No. 62/029,143, filed on Jul. 25, 2014.

(51) Int. Cl. G06Q 20/32; G06Q 20/40; G06Q 20/38; G06Q 20/34

(52) U.S. Cl. CPC G06Q 20/3278; G06Q 20/34; G06Q 20/322; G06Q 20/401; G06Q 20/382

(57) ABSTRACT

A mobile computing device has processors, memory, voice communication circuitry, and communication circuitry configured to receive a request from a server for information to complete an information exchange. The computing device also has a display device configured to display at least one user interface window in response to receiving the request from the server. The user interface window includes a plurality of data entry fields corresponding to the request. The computing device has a proximity based communication circuitry configured to energize an external proximity based card that is brought into proximity with the mobile computing device. When the external proximity based card is energized, the computing device receives information from the external proximity based card to populate at least one of the data entry fields. The communication circuitry is configured to submit data from the data entry fields to the server to facilitate the completion of the information exchange.

### RELATED APPLICATIONS

This application claims priority to U.S. Provisional Application Ser. No. 62/029,143, filed Jul. 25, 2014, which is incorporated by reference herein in its entirety.

### TECHNICAL FIELD

The disclosure relates generally to proximity based communication circuitry, and more specifically to proximity based communication circuitry for information interchange through a mobile communication device.

### BACKGROUND

Consumers can complete online transactions, such as electronic commerce using the Internet by purchasing goods and services from a merchant or other entity using a web browser. Commonly, a consumer visits a website to shop for goods or services and completes the online transaction by manually inputting credit card data and other information, such as an address. This requires the user to enter data into relevant text fields on a web page provided by the merchant. After the consumer submits the transaction, the data is then sent out to a third party for payment processing. To complete the transaction, the user may need to enter a substantial amount of data, including the card-holder's full name, the type of payment card (e.g., Visa™ or MasterCard™), the card number, the expiration date of the card, a Card Verification Value (“CVV”) or Card Verification Code (“CVC”), a security code, an address for the payment card, a delivery address, one or more phone numbers, an email address, and so on.

The requirement to manually enter this much data for a transaction is inconvenient, time consuming, and tedious. In some instances, the inconvenience of entering this data results in lost sales for the merchant or other entity.

This problem is exacerbated when users transact using smartphones and other mobile electronic communication devices, which tend to have smaller keyboards or virtual keyboards, which make data entry even more inconvenient.

Several approaches have been proposed to reduce the burden on users to manually input payment card and other data during the completion of online transactions (e.g., “check out”). Some systems provide a mobile Point-of-Sale service. This approach enables a user to have a mobile phone perform as a mobile Point-of-Sale (POS) terminal, such as that provided by SQUARE, INC. These mobile POS terminals generally require additional and separate hardware, which attaches to a mobile communications device to read payment card data. This approach, however, is inconvenient for users because it requires each user to have the separate POS device on their person at all times, which is again inconvenient. In addition, even if a user has one of these mobile POS devices, the user still needs to manually enter some data, such as address data and other personal data for each transaction.

Some companies, such as PAYPAL, offer online money transfer and processing. Such systems can be integrated into a merchant's website to allow users to make payments directly from their PAYPAL accounts. However, such systems still require the user to enter account details into a merchant's website for each transaction, and require users to link their accounts to one or more bank accounts or credit card accounts. Furthermore, the user still needs to enter address data and other personal data when the purchased item needs to be shipped.

Other systems provide specialized ecommerce platforms (e.g., AMAZON One-Click shopping, EBAY, and SHOPIFY). Users who are signed into their accounts on these platforms and who already have their payment data stored with the platform can make payment in a more efficient way. However, specialized ecommerce platforms require a time-consuming initial signup process to create an account with the platform and require the user to provide the platform with payment card data. Once an account is set up with the platform, the faster payment process applies only within the one particular platform. To streamline the process on other sites, the user generally must repeat the signup process for each platform. To streamline many platforms, the user would need to keep track of sign-in credentials for many accounts. In addition, having payment card or bank account data stored at many ecommerce platforms increases the risk of fraud.

As such, it is desirable to provide systems and methods that addresses some of these shortcomings of existing ecommerce systems.

### SUMMARY

The implementations disclosed herein address the above deficiencies and other problems associated with information interchange over a network, using information extracted from a proximity based communication card to simplify and streamline information interchange through a mobile communications device. A proximity-based card is activated when it comes into proximity with proximity-based circuitry of an electronic device, such as a smartphone. In some instances, the term “contactless” has been used to refer to proximity based communication with a proximity based card.

Some disclosed implementations facilitate information interchange over a network by using a proximity based communication module and/or proximity based communication circuitry of a mobile electronic communication device (e.g., a smartphone) to extract data from a proximity based communication card (e.g., a payment card with embedded near field communication capabilities). This eliminates or reduces the requirement for a user to manually input data into text fields within a web page for transmittal to a remote server.

In some implementations, the data input process is automated using communication between the mobile electronic communication device and proximity based communications circuitry or module inside a card. This process can be applied to any payment card that is equipped with a suitable proximity based communication circuitry, and can be applied to any electronic communication device that is equipped with a suitable proximity based communication circuitry or module. In some implementations, the electronic communication device extracts data from the card that is necessary to establish the card-holder's credentials. This can include the card-holder's full name, the type of card, the account number associated with the card, the expiration date of the card, a CVV or CVC number, any form of unique identification code and/or security code, address data, and other user data. In some implementations, the communication device outputs this data to corresponding fields of a web page. In other implementations, the data is transmitted directly to a remote server without first being inserted into the web page fields. In some instances, the fields are visible (e.g., for user verification/confirmation), but in other instances, the fields are hidden (e.g., for security). In some instances, the set of data entry fields for the web page includes both visible and hidden fields. This process of automatically completing web pages or forms greatly expedites the transaction or information exchange.

Some implementations facilitate online purchases, using a payment card that stores account data and other user data, and allows the data to be accessed using proximity based communication by proximity based communication circuitry/module of an electronic communication device. This data is extracted and used to provide names, account numbers, shipping addresses, and other information. In some instances, this data includes one or more of billing address, shipping address, user name, account number, full name, gender, date of birth, email address, and/or phone number.

In accordance with some implementations, a mobile computing device includes one or more processors, memory, and voice communication circuitry configured for facilitating a telephone call. The mobile computing device also includes communication circuitry configured to receive a request from a server for information to complete an information exchange, and a display device configured to display at least one user interface window in response to receiving the request from the server. The at least one user interface window includes a plurality of data entry fields corresponding to the request. The computing device includes proximity based communication circuitry configured to energize an external proximity based card that is brought into proximity with the mobile computing device. Upon energizing the external proximity based card, the computing device receives information from the external proximity based card to populate at least one of the plurality of the data entry fields. The communication circuitry is further configured to submit data from at least some of the plurality of data entry fields to the server to facilitate the completion of the information exchange.

In some implementations, the proximity based communication circuitry uses a near field communications protocol. In some implementations, the proximity based communication circuitry uses an RFID protocol.

In some implementations, the at least one user interface window further includes a prompt for user authentication before energizing the external proximity based card. In some implementations, the prompt for user authentication requires entry of a personal identification number or password by a user. In some implementations, the prompt for user authentication activates a biometric input device for user authentication.

In some implementations, the at least one user interface window further includes a prompt for user confirmation before submitting data from the data entry fields to the server.

In some implementations, the at least one user interface window further comprises a prompt for the user to populate at least one data entry field not populated by information extracted from the card.

In some implementations, the received information includes an expiration date associated with the card. In some implementations, the received information includes an account number. In some implementations, the received information includes an address corresponding to an owner of the card. In some implementations, the extracted information includes an encrypted value and the encrypted value is transmitted to the server or a third party for the transaction. In some implementations, a decryption key corresponding to the encrypted value is available at the server, but not available on the mobile computing device. In some implementations, the received information includes a one-time use token that is associated with an account number, and the submission module is configured to transmit the token to the server or a third party for the transaction.

In some implementations, the mobile computing device includes a database that stores user information used to populate one or more of the plurality of data entry fields upon receipt of the information from the external proximity based card. In some implementations, the stored user information includes an address corresponding to an owner of the card. In some implementations, a portion of the information from the external proximity based card forms a lookup key, and the database is configured to use the lookup key to locate the data for retrieval from the stored user information. In some implementations, the stored user information is encrypted, and the mobile computing device further comprises a decryption module configured to decrypt the stored user information using the information received from the external proximity based card as a decryption key.

In some implementations, the memory includes instructions to authenticate a user of the card as a prerequisite to receiving the information from the card.

In some implementations, the computing device includes a device authentication module configured to receive an authentication request from the server and to respond to the authentication request by providing a unique identifier of the mobile computing device. In some implementations, the unique identifier is a MAC address, an IP address, or a phone number.

In some implementations, the communication circuitry is further configured to transmit at least a portion of the data from the data entry fields to a third party distinct from the server.

In some implementations, a first data entry field of the plurality of data entry fields is populated with information received from the card and the first data entry field includes a visual indicator that the first data entry field is populated without displaying the information in the first data entry field.

In some implementations, the request from the server includes one or more data entry fields that are not displayed in the user interface window, the proximity based communication circuitry is configured to populate the one or more additional data entry fields with the received information, and the communication circuitry is configured to submit data from the additional data entry fields to the server for the transaction.

In accordance with some implementations, a mobile computing device has one or more processors, memory, and a display device. The computing device also includes a communication module configured to receive a request from a server for information to complete a transaction. The computing device also includes a user interface module configured to display a user interface window on the display device in response to receiving the request from the server. The user interface window includes a plurality of data entry fields corresponding to the request. The computing device includes a proximity based communication module configured to extract information from an external proximity based card when the card is brought into proximity with the mobile computing device, and to populate a plurality of the data entry fields using the extracted information. In addition, the computing device includes a submission module configured to submit data from the data entry fields to the server for the transaction.

In some implementations, the proximity based communication module uses a near field communications protocol. In some implementations, the proximity based communication module uses an RFID protocol.

In some implementations, the submission module is configured to prompt for user confirmation before submitting data from the data entry fields to the server for the transaction. In some implementations, prompting the user for confirmation comprises prompting the user to populate at least one data entry field not populated by information extracted from the card.

In some implementations, the extracted information includes an account number. In some implementations, the extracted information includes a date (e.g., an expiration date) corresponding to the card. In some implementations, the extracted information includes an address corresponding to an owner of the card.

In some implementations, the computing device includes a database module configured to store user information at the mobile computing device and to populate one or more of the data entry fields with data retrieved from the stored user information in response to a request from the user interface module. In some implementations, the stored user information includes an address of a user corresponding to the mobile computing device. In some implementations, a portion of the extracted information forms a lookup key, and the database module is configured to use the lookup key to locate the data for retrieval from the stored user information. In some implementations, the stored user information is encrypted, the database module is configured to decrypt the data retrieved from the stored user information, and the decryption uses the extracted information.

In some implementations, the computing device includes a user authentication module configured to authenticate a user of the card as a prerequisite to extracting the information from the card.

In some implementations, the computing device includes a device authentication module configured to receive an authentication request from the server and to respond to the authentication request by providing a unique identifier of the mobile computing device. In some implementations, the unique identifier is a MAC address, an IP address, or a phone number.

In some implementations, the submission module is configured to transmit at least a portion of the data from the data entry fields to a third party distinct from the server.

In some implementations, the extracted information includes an encrypted value and the encrypted value is transmitted to the server or a third party for the transaction. In some implementations, a decryption key corresponding to the encrypted value is available at the server, but not available on the mobile computing device.

In some implementations, the extracted information includes a one-time use token that is associated with an account number, and the submission module is configured to transmit the token to the server or a third party for the transaction.

In some implementations, a first data entry field of the plurality of data entry fields is populated with information extracted from the card and the first data entry field includes a visual indicator that the first data entry field is populated without displaying the information in the first data entry field.

In some implementations, the request from the server includes one or more data entry fields that are not displayed in the user interface window, the proximity based communication module is configured to populate the one or more additional data entry fields with the extracted information, and the submission module is configured to submit data from the additional data entry fields to the server for the transaction.

In accordance with some implementations, a method is performed at a mobile computing device having one or more processors and memory storing one or more programs configured for execution by the one or more processors. The method includes one or more operations performed by proximity based communication circuitry and/or software, network communication interfaces and software, biometric software drivers, cryptographic software, user authentication software, device authentication software, and/or database software, as described above for a mobile computing device.

In accordance with some implementations, a non-transitory computer readable storage medium stores one or more programs configured for execution by a mobile computing device having one or more processors and memory. The one or more programs comprise instructions for performing operations of proximity based communication circuitry and/or software, network communication interfaces and software, biometric software drivers, cryptographic software, user authentication software, device authentication software, and/or database software, as described above for a mobile computing device.

### BRIEF DESCRIPTION OF THE DRAWINGS

For a better understanding of the aforementioned implementations of the invention as well as additional implementations thereof, reference should be made to the Description of Implementations below, in conjunction with the following drawings in which like reference numerals refer to corresponding parts throughout the figures.

FIGS. 1A-1B provide a flowchart depicting the steps of a typical transaction conducted according to some implementations.

FIG. 2 is a conceptual diagram of the major components for conducting an online transaction according to some implementations.

FIG. 3 illustrates a process of conducting a transaction on a mobile device using proximity based communication card according to some implementations.

FIG. 4 is an alternative flowchart depicting the steps of a typical transaction conducted according to some implementations.

FIG. 5 is a block diagram of an electronic computing device according to some implementations.

FIG. 6 illustrates a context in which some implementations operate.

FIG. 7 is a block diagram of a server according to some implementations.

FIGS. 8-12, 13A, and 13B are data flow diagrams for a mobile computing device with proximity based communication circuitry according to some implementations.

FIGS. 14A-14D illustrate a process performed at a mobile computing device with proximity based communication circuitry according to some implementations.

Reference will now be made in detail to implementations, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details.

### DESCRIPTION OF IMPLEMENTATIONS

Terms and phrases used herein typically have meanings that are understood by those of skill in the art.

The term “address data” includes any data that pinpoints a user's address. In some instances, address data helps to establish a payment card-holder's credentials or facilitates shipping and delivery of goods. In some instances, address data is gathered for marketing, operations, user identification, access control, attendance, or other general purposes. In some user interfaces or web pages, address data is labeled as a “billing address,” a “shipping address,” or an “address.”

A “browser or “web browser” is a software application for retrieving, presenting and traversing information and data resources on the World Wide Web. A browser typically serves as an interface for a user to the Internet. A browser can be installed and used on many types of electronic devices, including smartphones, tablets, smart TV's, gaming consoles, entertainment systems, PCs, laptops, and smart appliances. In some implementations, the browser software may be modified or enhanced (e.g., with software plugins) to work with some of the disclosed implementations.

A “card-holder” is an individual person, a partnership, a group, an organization, or another entity that can use a payment card. A card-holder may be the owner of the card, a trustee of the card, or a non-owner with permission from the owner to use the card.

The term “proximity based communication(s)” includes any form of close range proximity based communication that uses a proximity based communication module. Examples include Near Field Communication (NFC) and Radio Frequency Identification (RFID). The effective communication proximity between two proximity based communications modules typically has limited physical range (e.g., ten centimeters, an inch, or a couple of inches).

The term “dedicated app” refers to integration software implemented on an electronic communication device that facilitates access between a browser (standard or customized) and a proximity based communication module. In some implementations, the software runs in the background (e.g., a hidden application) or as a application with an actionable user interface. In some implementations, the software is a customized browser. The dedicated app typically runs on a smart phone, a tablet computer, a smart TV, a gaming console, an entertainment system, a smart appliance (e.g., Android platform devices), an iOS device, or a Blackberry platform smart phone.

The phrase “dedicated or standard API” refers to integration software implemented on a website or the servers of a merchant or other website owner. A dedicated or standard API is used to facilitate integration and communication between the website and the proximity based communication module of the electronic communication device.

A “dedicated payment card” is a payment card that has the regular functionality of a payment card (e.g., a credit card or debit card), but also stores and provides output data. In some instances, dedicated payment cards include functionality whereby data stored on the card may be modified by an external electronic communication device. Such data may include address data, other user data, and payment data. Examples of dedicated payment cards include VISA, MASTERCARD, UNIONPAY, and AMEX cards that are enhanced to store and output extra data, such as address data and other user data. Some dedicated payment cards can interoperate with electronic communication devices that have embedded proximity based technology.

A “dedicated plug-in” is integration software implemented on an electronic communication device that facilitates access between a web browser and the proximity based communication module. A dedicated plug-in is commonly used on PC-based web browsers, such as GOOGLE CHROME, MICROSOFT INTERNET EXPLORER, MOZILLA FIREFOX, and APPLE SAFARI.

The term “dedicated terminal” includes electronic communication devices that are configured to support the disclosed techniques for proximity based communication with a card. Dedicated terminals can be mobile or stationary, and are typically enabled with proximity based communications. In typical applications, dedicated terminals are used to read payment card data via proximity based communications. In some implementations, dedicated terminals can read and/or write data via proximity based communications to various computing devices. Such devices include payment cards, dedicated payment cards, smartcards, and other electronic communication devices. Dedicated terminals belong to an entity (such as a merchant) that is not the user. The entity typically provides a website or other user interface for a user to access. Examples of these entities include retail merchants, public safety enforcers, and service providers.

An “electronic communication device” is an electronic device that has the ability to communicate with a payment card and/or other electronic devices. Electronic communication devices include smartphones, tablet computers, laptop computers, smart-watches, media players, remote control devices, desktop computers, computer monitors, game consoles, hand-held game controllers, printers, photocopiers, smart appliances, electronic locking devices, electronic door locks, and electronic door strikes. Electronic communication devices are commonly mobile computing devices.

The term “entity” refers to an individual, a partnership, a merchant, a business, or an organization whose scope of operations includes providing products or services to users, the public, governments, or other entities.

The term “encounter” refers to situations where a user goes to an entity at a physical environment, typically to procure products or services from the entity. In addition to exchange of products or services, an encounter typically involves the exchange of data and/or information. Typically an encounter involves one or more transactions, but that is not required. Information that is commonly exchanged includes payment data, address data, and other user data.

The term “other user data” includes any data not included in “payment data” or “address data” that an entity may require a user to enter to process a transaction or other encounter. In some instances, other user data includes the user's email address, phone number, unique user ID, other security-related data, and individual demographic data such as full name, gender, date of birth, and any sort of variable/modifiable data such as an account balances, points, user status, or variable security-related data. Other user data can be used for helping establish a payment card-holder's credentials, gathering user data for marketing, operations, user identification, access control, attendance, and so on.

In some implementations, a “payment card” is a physical card that can facilitate transactions. Examples of payment cards include credit cards, debit cards, other smartcards, stored-value cards, gift cards, dedicated payment cards, contactless tags, contactless stickers. In some implementations, a “payment card” is an electronic device (e.g., a smartphone) that is configured to mimic credit cards or debit cards.

The term “payment data” includes any data from a payment card that is necessary for an entity (such as a payment processing company, bank, or other financial institution) to establish the credentials of the card-holder(s). As noted above, a card-holder may be an owner of the card, a trustee of the card, or a non-owner with permission from the owner to use the card. Payment data is typically displayed physically on a payment card such as a credit card. Such data may include the card-holder's full name, the type of payment card, the payment card number, the expiration date of the payment card, any form of security code, and/or a CVV or CVC number. Payment data may also include data not displayed physically on the payment card. In some instances, non-displayed data includes a unique identification number and/or data related to security protocols.

The term “physical environment” refers to physical space where products and services are provided. A physical environment is typically owned (or leased) by an entity. Physical environments include retail space (e.g., “brick and mortar”), event space, living quarters, administrative space, registrar environments, or an environment that supports a combination of these elements. Examples of such operations conducted at a physical environment include transactional activities, exchange activities, provision of goods or services, administrative activities, check-ins and check-outs, identification, ticketing, access control, attendance, registration functions, and loyalty programs.

A “tap” is an action taken by a user whereby the user brings a proximity based card within an effective communication proximity to a proximity based communication enabled electronic communication device such that the proximity based communication circuitry or modules of the device and the card can establish a connection. This energizes the card and enables the electronic communication device to receive data from the card.

A “website” can be accessed by a device with a web browser. In many instances, a user browses a website in order to conduct commerce. A website is typically owned or managed by an entity that is providing goods or services.

Disclosed implementations allow an individual to use an electronic communication device that is equipped with proximity based communications circuitry and associated software to communicate using proximity based communication with a card that is configured for proximity based communication. This facilitates various forms of information interchange, including information used for electronic commerce (e-commerce) and mobile commerce (m-commerce). In some implementations, the information interchange occurs during a checkout process when a user is purchasing goods or services.

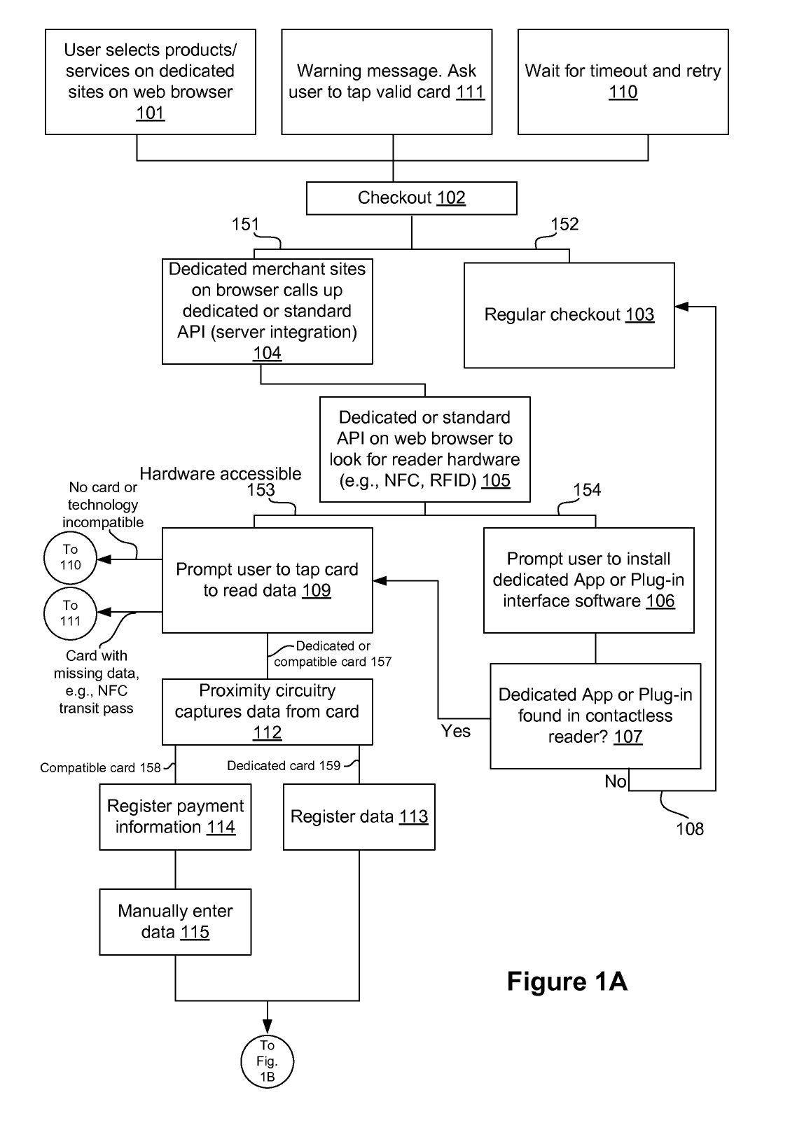

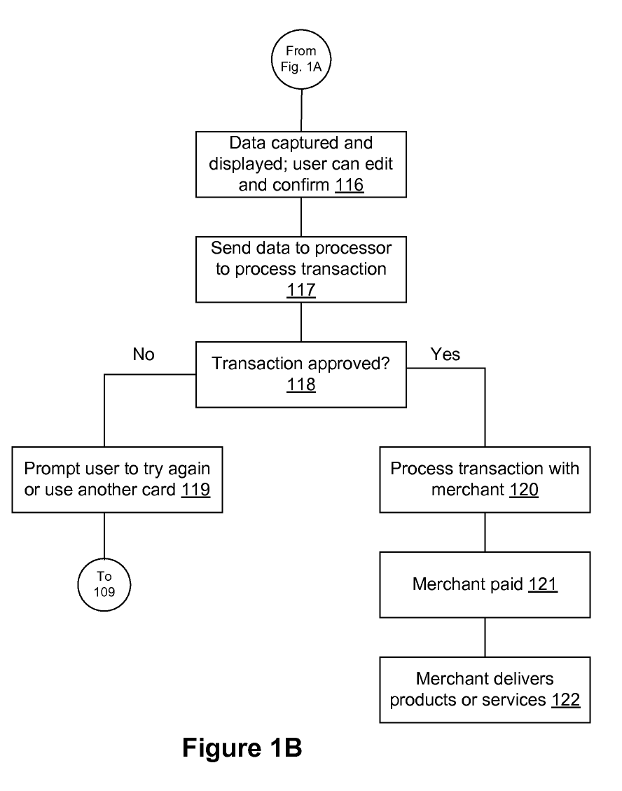

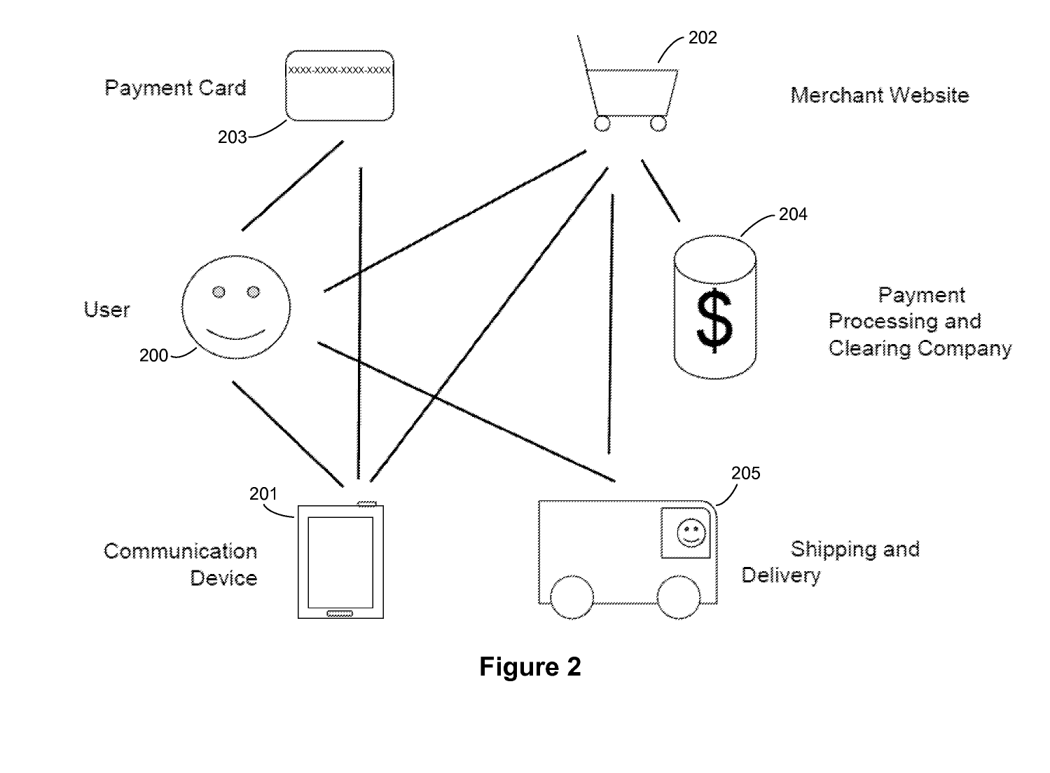

FIGS. 1A and 1B provide a flowchart depicting the steps for some implementations. A user 200 shops online by visiting an e-commerce enabled website using a web browser on an electronic communication device, such as a web-enabled smartphone. The user 200 intends to make a purchase. FIG. 2 is a simplified diagram of the main components involved in the process illustrated in FIGS. 1A and 1B. In steps 101 and 102, the merchant's or other entity's e-commerce website 202 readies the customer checkout interface and presents the user 200 with a choice of payment methods. Step 103 represents the regular checkout process where the user 200 elects (152) to pay using a regular payment method, such as by manually entering credit card data. The user 200 may alternatively elect (151) to pay using components and techniques disclosed herein, as generally represented by steps 104-122. The process of steps 104-122 utilizes the proximity based communications circuitry or module of an electronic communication device 201 to extract the payment and delivery details directly from the proximity based communications circuitry or module of the payment card 203. In steps 104 and 105, using the dedicated or standard API between the merchant's website 202 and the web browser being used, the dedicated or standard API attempts to energize the proximity based communication module. If the proximity based communication module of the electronic communication device 201 is not readily accessible (154), the user 200 is prompted (step 106) to install a dedicated app or dedicated plug-in software that would facilitate in engaging the proximity based communication module of the electronic communication device 201.

Once the dedicated app or dedicated plug-in is installed, the “system” (which may include the dedicated or standard API, the website, or the electronic communication device's operating system) tries to access the proximity based communication module once again (step 107). If this fails (108) again (e.g., because the proximity based communication module is inaccessible or non-existent in the electronic communication device 201), the website returns the user to step 106, 103, or 102, depending on how the website is configured.

If the proximity based communication circuitry or module of the electronic communication device 201 is successfully accessed (153), in step 109 the merchant's or other entity's website 202 prompts the user 200 to tap a proximity based communication enabled payment card 203 against the electronic communication device 201. If the proximity based communication circuitry or module of the electronic communication device has not detected (155) another proximity based communication circuitry or module of a payment card or other device within a predefined period of time (e.g., 5 seconds or 10 seconds), the system (which may include the dedicated or standard API, the website or the electronic communication device's operating system) times-out (step 110) and typically returns the user to step 102. If the proximity based communication circuitry or module of the electronic communication device does detect a proximity based communication circuitry or module of a payment card or other device within the predefined period of time, but errors arise (156), the system notifies the user of the error (step 111) and returns the user to step 109 or 102, depending on how the website is configured. Errors can occur for many reasons, including compatibility, purpose of use, missing data, or security.

If the proximity based communication module of the electronic communication device 201 does detect proximity based communication circuitry or module of a payment card or other device within the predefined period of time and a connection is successfully established without error (157), the proximity based communication circuitry or module of the electronic communication device 201 extracts available data from the payment card 203 (step 112).

If the payment card 203 has only payment data available (158), the payment data is extracted (step 114) to facilitate the transaction process, but the user 200 may then also need to manually input address data (step 115) to facilitate shipping and delivery of goods 205, as well as other user data as required by the merchant or other entity's website 202. After the data is collected by the website, the processed data is displayed on the electronic communication device's screen for verification (step 116). During this step, the user 200 may edit the displayed data and manually input any remaining data that the website 202 requires that was not previously entered or provided. In some implementations, one or more data entry fields cannot be edited by the user once they are filled by the Tap application/plugin 550. This can be used to guarantee authenticity (e.g., the data has not been manipulated) of the data retrieved by the Tap application/plugin 550.

If the payment card 203 is a dedicated payment card (159), the proximity based communication module of the electronic communication device 201 captures the payment data, address data, as well as other user data as required by the website 202 (step 113). In some implementations, step 113 proceeds to step 116 for verification. In other implementations, after performing step 113, the system skips straight to step 117.

Referring to steps 117 and 118, the payment data collected by the website 202 is sent for verification and payment processing 204. If the transaction is not approved, the user is prompted (119) to try again or use another card. Depending on the configuration of the website, the next step is typically step 116, step 109, or step 102. If the transaction is approved and successful, the merchant or other entity 202 is paid and prepares to deliver the products/services ordered 205, as illustrated in steps 120-122.

In some implementations, a user 200 makes an e-commerce purchase through a website displayed on a web browser using a near field communication (NFC) enabled smartphone. This involves utilizing the NFC module of the smartphone (e.g., ANDROID smartphone, APPLE IPHONE or BLACKBERRY device) 201 to extract the payment and delivery details from a payment card 200 through the NFC module embedded in it (e.g., via VISA PAYWAVE or MASTERCARD PAYPASS). In steps 101-102, the entity's commerce website 202 presents the user 200 with a choice of payment methods at the checkout interface, and the user 200 elects (151) to pay using a system as disclosed herein and described in steps 104-122.

In steps 104 and 105, the dedicated or standard API between the merchant's website and the web browser of the smartphone attempts to initiate the NFC module of the smartphone 201. The API activates or energizes the NFC module directly from the browser. Once the NFC module in the smartphone 201 is successfully accessed, then in step 109 the user 200 is prompted to tap an NFC enabled payment card 203 (e.g., credit card) against the NFC enabled smartphone 201. Once the NFC connection between the devices is established successfully, the smartphone extracts available data from the payment card 203 (step 112).

When the payment card 203 is a dedicated payment card that is able to carry additional data such as address data and other user data, the NFC module of the smartphone 201 captures the available data stored in the payment card 203, depending on what data is required by the website 202 (step 113), so that the user does not need to manually input the data.

After the data is collected by the website 202, some websites 202 display the received data, giving the user an opportunity to verify and edit (step 116). Other websites are configured to skip this step and send the processed data directly for payment processing (step 117).

In some implementations, payment data is collected by the website to facilitate a transaction process, along with address data and other user data (e.g., for shipping). In some implementations, any combination of payment data, address data, and other user data is collected during information exchange that does not involve a transaction. For example, a user may register at a social website or an online forum, and the information in the card is used to simplify the registration process.

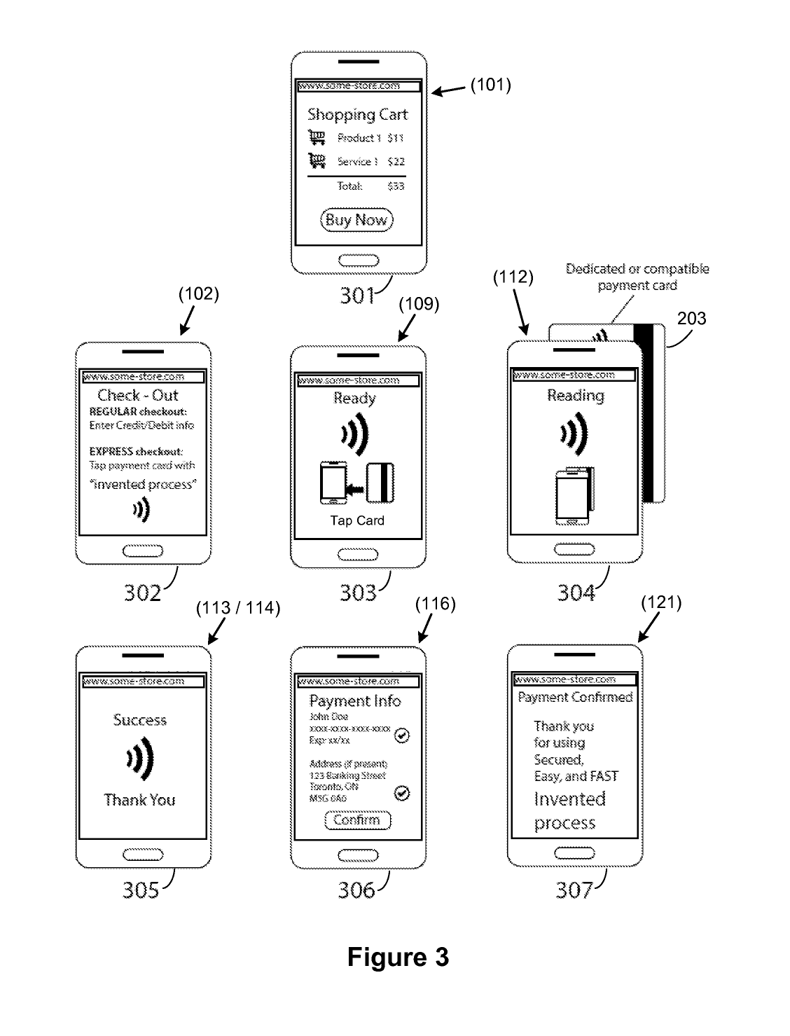

FIG. 3 illustrates a process of conducting a transaction on a mobile device using on proximity based communication card according to some implementations. FIG. 3 illustrates sample on-screen messages displayed during the various steps in FIGS. 1A and 1B from the perspective of a smartphone user. A user 200 seeks to make an online purchase using an electronic communication device 201. The user 200 accesses a merchant's or other entity's website 202, which is enabled for payment using a system as disclosed herein, and elects (151) to pay using either a dedicated payment card, or a proximity based communications enabled payment card that is compatible with the system. The reference numbers in parentheses in FIG. 3 (e.g., (101)) identify the corresponding step or steps in FIGS. 1A and 1B where the sample on-screen messages are shown.

Initially, a user 200 chooses the products and services to buy (301). The user then proceeds to checkout and chooses the desired method of payment (302). If the user elects to proceed to pay using a system as disclosed (also referred to in 302 as the “invented process”), the user is prompted (303) by his electronic communication device to tap a payment card against the electronic communication device.

Depending on the type of payment card used, the scenario branches into one of the following two scenarios. In a first scenario, the user in step 304 taps a dedicated payment card 203 against the electronic communication device 201, which initiates data extraction from the dedicated payment card. The extracted data includes payment data, any address data, and any other user data needed to populate corresponding fields in the web page displayed on the electronic communication device. If the data extraction is not successful, the user is notified and be returned to step 302 or 303. If the data extraction is successful, the user is notified of the success in step 305.

In a second alternative scenario, the user in step 304 taps a proximity based communications enabled payment card against his electronic communication device that is compatible with the implementation of invented process. In this scenario, the payment card is not a dedicated payment card. In this case, the system initiates extraction of just payment data from the payment card, and places the extracted data into corresponding fields on the displayed web page on the electronic communication device. If the data extraction is not successful, the user is notified and returned to step 302 or step 303. If the data extraction is successful, the user is notified in step 305. Some web pages require additional information, such as address data and other user data. The user 200 manually enters data into these fields because the data is not stored in the payment card.

After the previous steps, the website typically gives the user the opportunity (306) to verify, edit, and confirm any data that was entered into the web page, regardless of whether extracted from a payment card or entered manually. The user at this point can modify, add, and/or remove data (e.g., even overriding data extracted from the payment card). The user then manually submits the data, and the website provides confirmation. In some implementations, the submission of the transaction is automated after the data entry fields are filled and does not require manual submission by the user. The order then undergoes merchant processing. Some websites skip step 306 after step 305, and go straight to providing confirmation and order processing. Once the confirmation, payment, and merchant processing are successful, the website notifies the user in step 307 that the transaction is successful. Some websites provide a later notification that the delivery of goods and/or services is being arranged, or that an item has been shipped.

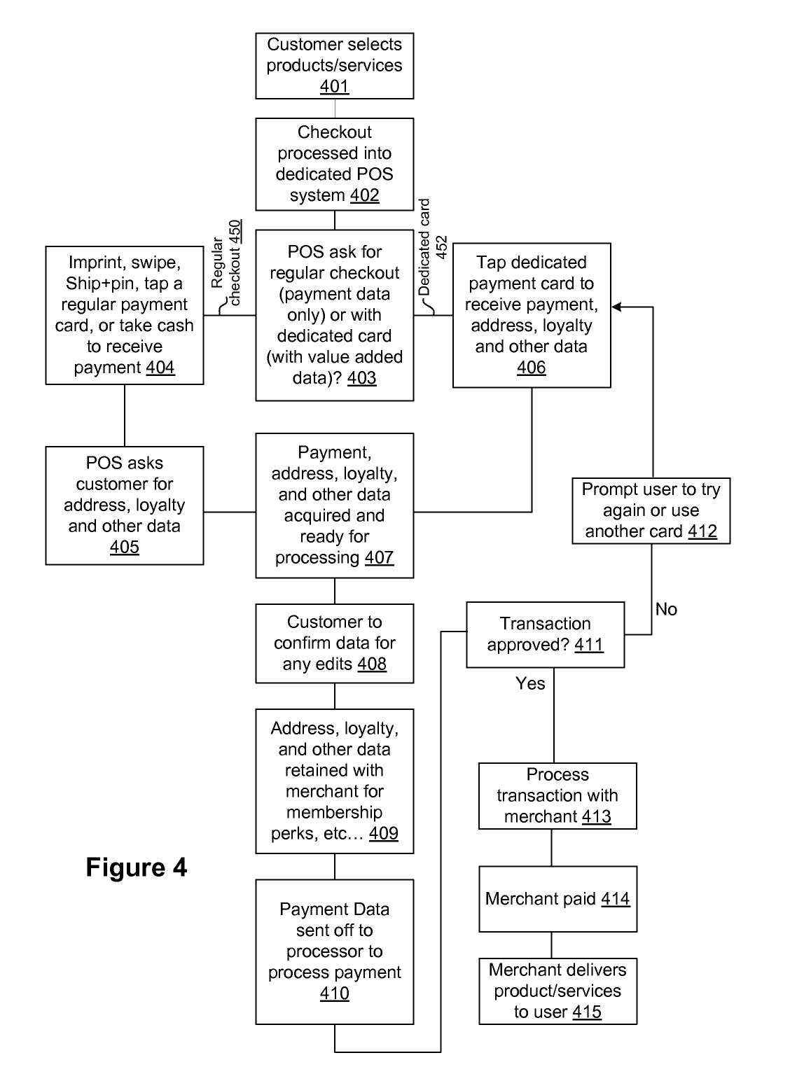

FIG. 4 is a flowchart depicting the steps of a typical encounter/transaction conducted at a physical environment (e.g., a “bricks & mortar” location). Steps 401-415 of this process allow a user 200 to tap a proximity based communication enabled payment card or dedicated payment card on a dedicated terminal at the physical environment. This can initiate various functionality, such as facilitating a transaction, performing loyalty program related functions, identifying the user, controlling access, verifying attendance, conducting surveys, or providing data for subsequent statistical analysis. In some instances, the payment card facilitates a registration process. In some instances, data from the payment is used for multiple functions. In some implementations, a transaction uses payment data collected during an encounter, and other data (such as address data) is collected at the same time. In some implementations, data is collected without a transaction.

Typically, a user 200 (step 401) selects products and/or services at the physical environment, and any required data regarding the product/service selection process is input into the entity's system (step 402). Then at step 403, the user is presented a choice between processing the encounter/transaction using a regular method (450) (represented by steps 404 and 405), or processing the encounter/transaction using an enhanced process (452) as disclosed (represented by step 406). The regular checkout process uses (404) a card imprint, a swipe, PIN, etc., to enter payment data, and the POS system or clerk may ask (405) the customer for additional data.

During step 406, a user 200 is prompted to tap a dedicated payment card against the dedicated terminal, and the terminal attempts to extract payment data, address data, and/or other user data from the dedicated payment card. If this process fails, the user may need to repeat step 406, or may be returned to step 403. If the process of the data extraction is successful, the extracted data from any combination of payment data, address data, and/or other user data is acquired by the entity, as indicated in step 407.

In step 408 the entity typically gives the user 200 the opportunity to verify, edit, and confirm any data that was acquired by the entity. In some physical environments the user at step 408 can modify, add, and/or remove data manually. The user submits the data during this step and then goes to step 409 or step 410. In some implementations, the submission of the transaction is automated after the data entry fields are filled and does not require manual submission by the user. Optionally, the processing may be set up such that after step 407, it goes straight to step 409 or step 410, skipping step 408.

The next step is either step 409 or step 410 depending on the configuration of the dedicated terminal. In some implementations, these two steps can occur simultaneously. In other implementations, these two steps occur sequentially (in either order), and the fulfillment of either step is not a necessary condition for the initiation and/or fulfillment of the other. For example, depending on the nature of the transaction/encounter, it is possible that the process involves going to step 409 and omitting step 410, or going to step 410 and omitting step 409. At step 409 the entity typically retains some or all of the payment data, address data, and/or other user data that was entered from the previous steps. This data is typically retained for operations, marketing, surveys, attendance, access control, ticketing, data analysis, and/or facilitation of step 410. At step 410, any payment data, address data, and/or other user data that is required to facilitate a transaction is sent to the payment processor 204 to process the transaction.

In step 411, if the transaction/encounter fails to process with the payment processor 204, the user 200 is notified (step 412). In this case, the user is either returned to step 408 to re-attempt to verify, edit, and submit the data, brought back to step 406 to re-attempt to tap the dedicated payment card against the dedicated terminal, or brought back to step 403 to choose another method of payment.

If the transaction is successfully processed with the payment processor 204 in step 411, then at steps 413 to 415 the details of the transaction are recorded with the entity, the entity is paid, and the delivery of products and/or services to the user 200 is arranged.

Some implementations use dedicated payment cards. These are payment cards that have the regular functionality of payment cards, but are modified or enhanced to store and output data in addition to the scope of regular payment cards. Dedicated payment cards typically include functionality to modify the stored data using an electronic communication device. The embedded proximity based communication module of the dedicated payment card facilitates exchange of data between the card itself and an electronic communication device.

To initiate data exchange, the proximity based communication module of the electronic communication device is activated and the electronic communication device is in a state where it is ready to exchange data with the payment card. In this “ready” state, the electronic communication device typically provides an indicator of the state to the user. The user can then tap the dedicated payment card on the electronic communication device. Once these devices are within effective communication proximity, the electronic communication device initiates data exchange.

In an exchange, any combination of payment data, address data, and other user data may be modified. Many different factors determine what data gets exchanged. The data that is modified depends on the nature and purpose of the exchange, activities involved in and related to the exchange, security protocols of the card and/or electronic communication device, government regulations, requirements of the entity that is serving the user, and preferences of a user.

In some implementations, a transaction involves exchange of payment data between the card and an electronic communication device. In an e-commerce or m-commerce shopping process, address data and other user data is also exchanged in order to streamline the data input for shipping information. In some implementations, a transaction is not required during an exchange/encounter and any combination of some or all of the payment data, the address data, and other user data are collected during the exchange/encounter for reasons that do not involve a transaction.

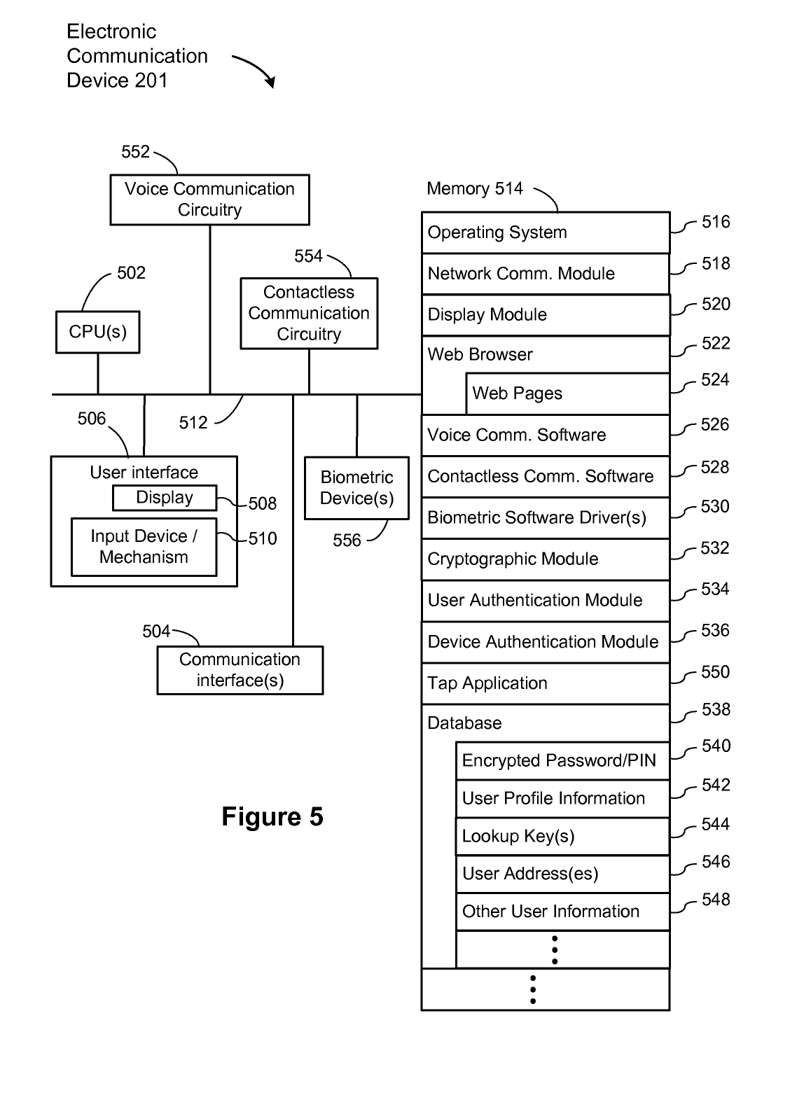

FIG. 5 is a block diagram illustrating an electronic computing device 201. An electronic computing device is also referred to as a computing device, a client device, or a client computer. The computing device may be a tablet computer, a laptop computer, a smart phone, a desktop computer, a PDA, or other computing device than can run a web browser 522 and has access to a communication network 608. When the client device is mobile, it is sometimes referred to as a mobile client device or a mobile computing device. A client device 201 typically includes one or more processing units (CPUs) 502 for executing modules, programs, or instructions stored in memory 514 and thereby performing processing operations; one or more network or other communications interfaces 504; memory 514; and one or more communication buses 512 for interconnecting these components. The communication buses 512 may include circuitry (sometimes called a chipset) that interconnects and controls communications between system components. A client device 201 includes a user interface 506 comprising a display device 508 and one or more input devices or mechanisms 510. In some implementations, the input device/mechanism includes a keyboard and a mouse; in some implementations, the input device/mechanism includes a “soft” or virtual keyboard, which is displayed as needed on the display device 508, enabling a user to “press keys” that appear on the display 508. In some implementations, the display 508 and input device 510 are combined in a touch-sensitive display.

In some implementations, the memory 514 includes high-speed random access memory, such as DRAM, SRAM, DDR RAM or other random access solid state memory devices. In some implementations, the memory 514 includes non-volatile memory, such as one or more magnetic disk storage devices, optical disk storage devices, flash memory devices, or other non-volatile solid state storage devices. In some implementations, the memory 514 includes one or more storage devices remotely located from the CPU(s) 502. The memory 514, or alternately the non-volatile memory device(s) within the memory 514, comprises a non-transitory computer readable storage medium. In some implementations, the memory 514, or the computer readable storage medium of the memory 514, stores the following programs, modules, and data structures, or a subset thereof:
an operating system 516, which includes procedures for handling various basic system services and for performing hardware dependent tasks;
a network communication module 518, which is used for connecting the client device 201 to other computers and devices via the one or more communication network interfaces 504 (wired or wireless) and one or more communication networks 608, such as the Internet, other wide area networks, local area networks, metropolitan area networks, and so on;
a display module 520, which receives input from the one or more input devices 510, and generates user interface elements for display on the display device 508;
a web browser 522, which enables a user to communicate over a network 608 (such as the Internet) with remote computers or devices (e.g., a server 602), and displays web pages 524 that are retrieved from those remote computers or devices;
voice communication software 526, which works with the voice communication circuitry 552 to enable phone calls between the client device 201 and other telephonic devices;
proximity based communication software 528, which works with the proximity based communication circuitry 554 to communicate over short distances with a wireless communication module embedded in a card. In some implementations, the proximity based communication software 528 and circuitry 554 use a near field communication (NFC) protocol or an RFID protocol;
one or more biometric software drivers 530, which provide access to the biometric hardware devices 556. The biometric software drivers 530 and biometric devices utilize one or more human features, such as a fingerprint, a retinal scan, or a unique hand gesture to authenticate a user;
a cryptographic module 532, which encrypts or decrypts data to protect the security of a user, the user's personal information, account information, and other critical information. In some implementations, the cryptographic module is implemented partially or fully in hardware;
a user authentication module 534, which is used in some implementations to verify a user before extracting data from a payment card. In some implementations, the user authentication module accesses one or more biometric devices 556 for authentication. In some implementations, the user authentication module requires input of a password or personal identification number, and compares the entered data to a stored value 540 (e.g., an encrypted password or PIN);
a device authentication module 536, which provides a unique identifier for the device 201 for certain communication with remote servers 602. In some implementations, the device authentication module uses a MAC address, an IP address, or a phone number as the unique identifier for the device;
a Tap application 550, which is also referred to as a “dedicated application.” A tap application facilitates retrieval and usage of information stored on a proximity based card. In addition, the Tap application automatically collects and stores manually entered information (e.g., user addresses 546 and other user information 548) during a transaction when permitted by the user. This information that is collected and stored is used during later transactions, reducing the amount of manual data entry;
one or more databases 538, which store data in non-volatile storage. In some implementations, the database 538 stores one or more encrypted passwords or PINS 540, which are used during authentication. In some implementations, the database 538 stores user profile information 542, which tracks user preferences or configuration options. In some implementations, the database 538 stores one or more lookup keys 544, which are used to correlate account information retrieved with a payment card to a user address 546 or other user information 548. For example, a user may have two or more payment cards, and the stored user information is different depending on which card is used (e.g., different billing addresses).

Each of the above identified executable modules, applications, or sets of procedures may be stored in one or more of the previously mentioned memory devices and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 514 may store a subset of the modules and data structures identified above. Furthermore, the memory 514 may store additional modules or data structures not described above.

Although FIG. 5 shows a client device 201, FIG. 5 is intended more as a functional description of the various features that may be present rather than as a structural schematic of the implementations described herein. In practice, and as recognized by those of ordinary skill in the art, items shown separately could be combined and some items could be separated.

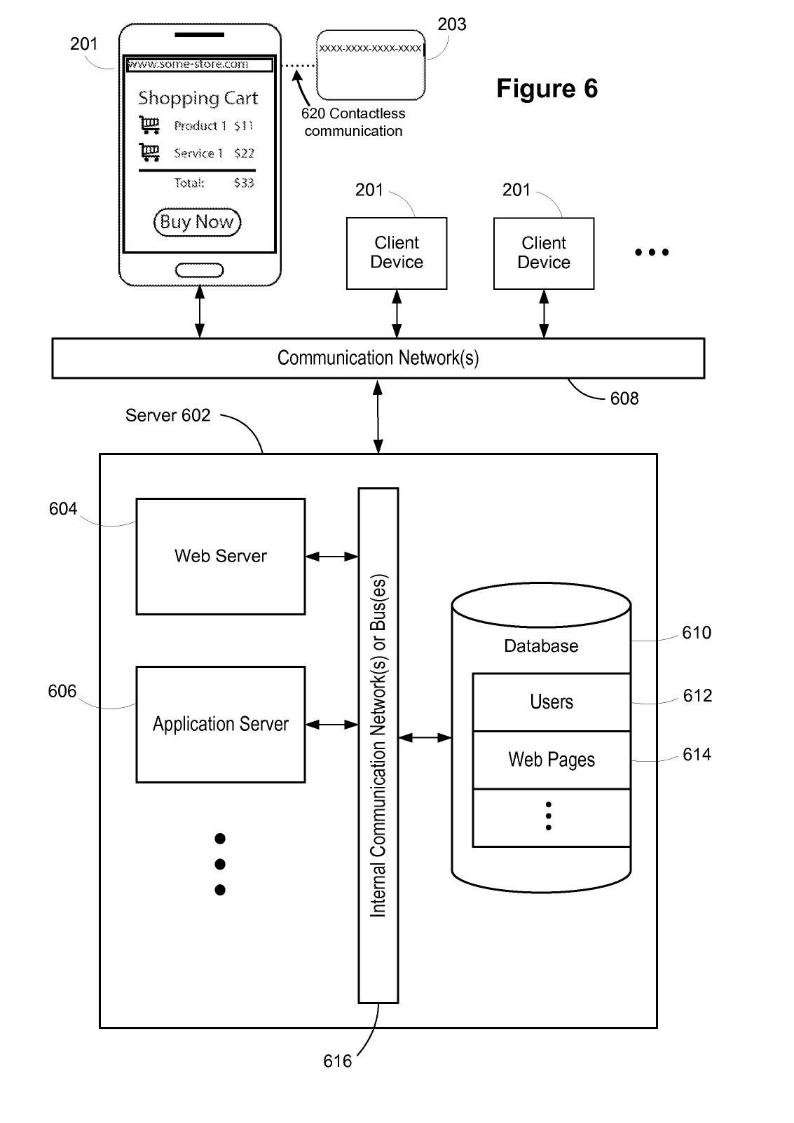

FIG. 6 is a block diagram that illustrates a context in which some implementations operate. Client devices 201 connect to a server 602 using one or more communication networks 608. The server 602 typically includes a web server 604, such as an Apache HTTP server, which delivers web pages 614 and other resources to client devices 201 when requested. In some implementations, the server also includes an application server 606, which provides one or more applications 722 for use by client devices. In some implementations, the server stores data in one or more databases 610. In some implementations, the database stores user information 612 and web pages 614, which may be requested by users. In some implementations, the database 610 includes a log, which tracks various events, such as resource requests and purchases by users. In some implementations, the server includes one or more internal communication networks or buses 616.

As illustrated in FIG. 6, when a payment card 203 is brought into proximity with a client device 201, it initiates proximity based communication 620 between the proximity based communication circuitry in the client device 201 and the proximity based communication module in the payment card 203.

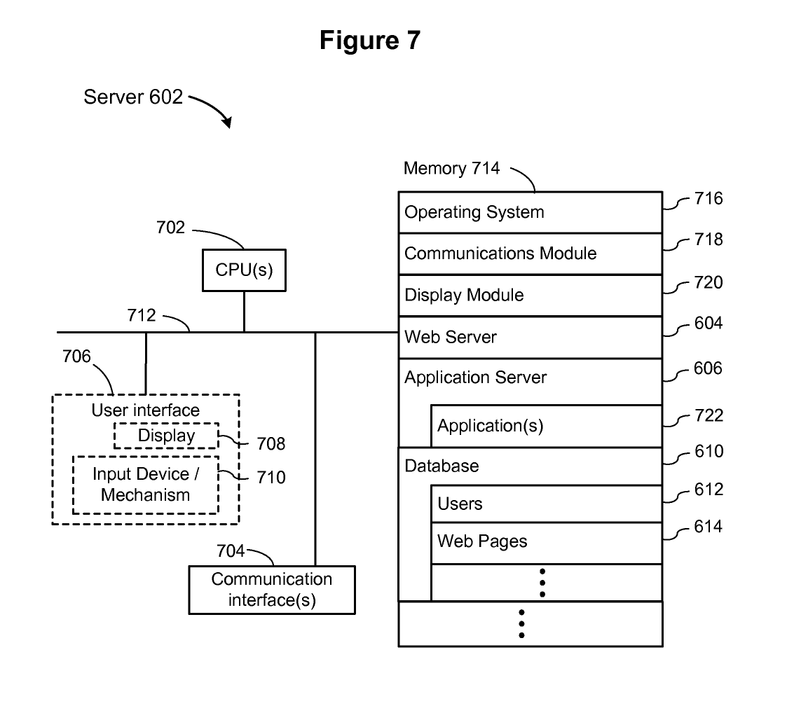

FIG. 7 is a block diagram illustrating a server 602. In some implementations, a server 602 includes many individual server computers, which may be connected by an internal network or bus 616, as illustrated in FIG. 6. A server 602 typically includes one or more processing units (CPUs) 702 for executing modules, programs, or instructions stored in the memory 714 and thereby performing processing operations; one or more network or other communications interfaces 704; memory 714; and one or more communication buses 712 for interconnecting these components. The communication buses 712 may include circuitry (sometimes called a chipset) that interconnects and controls communications between system components. In some implementations, a server 602 includes a user interface 706, which may include a display device 708 and one or more input devices 710, such as a keyboard and a mouse.

In some implementations, the memory 714 includes high-speed random access memory, such as DRAM, SRAM, DDR RAM or other random access solid state memory devices. In some implementations, the memory 714 includes non-volatile memory, such as one or more magnetic disk storage devices, optical disk storage devices, flash memory devices, or other non-volatile solid state storage devices. In some implementations, the memory 714 includes one or more storage devices remotely located from the CPU(s) 702. The memory 714, or alternately the non-volatile memory device(s) within memory 714, comprises a non-transitory computer readable storage medium. In some implementations, the memory 714, or the computer readable storage medium of memory 714, stores the following programs, modules, and data structures, or a subset thereof:
an operating system 716, which includes procedures for handling various basic system services and for performing hardware dependent tasks;
a communications module 718, which is used for connecting the server 602 to other computers (e.g., client devices 201) via the one or more communication network interfaces 704 (wired or wireless), an internal network or bus 616, or other communication networks 608, such as the Internet, other wide area networks, local area networks, metropolitan area networks, and so on;
a display module 720, which receives input from one or more input devices 710, and generates user interface elements for display on a display device 708;
one or more web servers 604, which receive requests from client devices 201, and return responsive web pages, resources, or links. In some implementations, each request is logged in the database 610;
one or more application servers 606, which provide various applications to the client devices 201. In some instances, applications are provided as a set of web pages 614, which are delivered to the client devices 201 and displayed in a web browser 522. The web pages 614 are delivered as needed or requested. In some instances, an application is delivered to a client device 201 as a download, which is installed and run from the client device 201 outside of a web browser 522;
one or more databases 610, which store various data used by the modules or programs identified above. In some implementations, the database 610 includes a list of authorized users 612, which may include user names, encrypted passwords, and other relevant information about each user. The database 610 also stores user specific data that is used by one or more of the applications provided by the application server 606. The database 610 also stores web pages that are available to users as part of a website.

Each of the above identified elements in FIG. 7 may be stored in one or more of the previously mentioned memory devices. Each executable program, module, or procedure corresponds to a set of instructions for performing a function described above. The above identified modules or programs (i.e., sets of instructions) need not be implemented as separate software programs, procedures or modules, and thus various subsets of these modules may be combined or otherwise re-arranged in various implementations. In some implementations, the memory 714 may store a subset of the modules and data structures identified above. Furthermore, the memory 714 may store additional modules or data structures not described above.

Although FIG. 7 illustrates a server 602, FIG. 7 is intended more as functional illustration of the various features that may be present in a set of one or more servers rather than as a structural schematic of the implementations described herein. In practice, and as recognized by those of ordinary skill in the art, items shown separately could be combined and some items could be separated. The actual number of servers used to implement these features, and how features are allocated among them, will vary from one implementation to another, and may depend in part on the amount of data traffic that the system must handle during peak usage periods as well as during average usage periods.

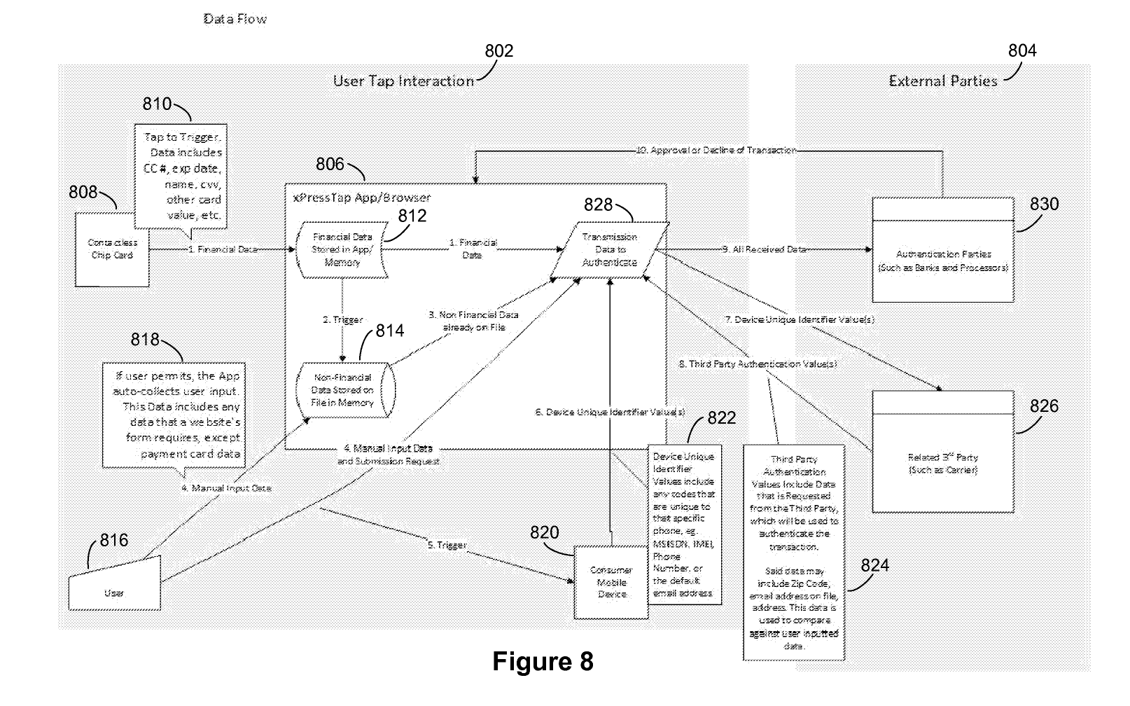

FIG. 8 illustrates the data flow in some implementations. The data flow can be organized into two general categories: a first portion 802 that involves user tap interaction and a second portion 804 involving data flow to and from external parties. A portion 806 of the user tap interaction 802 is performed by a Tap application/plugin 550.

A proximity based chip card 808 (also referred to as a payment card or proximity based card) stores data, such as payment data (e.g., a credit card number) and personal data (e.g., a billing address or an email address). When the card 808 is brought into proximity or tapped (810) to a mobile computing device 201, data is transferred to the device 201. The data may include a credit card number, an expiration date of the credit card, the name of the credit card holder, a CVV value, and/or other information. The extracted data is stored (812) in the memory.

In some instances, the extracted data triggers retrieval (814) of data stored locally on the mobile computing device 201. In some implementations, a portion of the extracted information is used as a lookup key 544 to identify corresponding locally stored information. In some implementations, the locally stored information was automatically collected (818) from previous user input when authorized by the user 816. The locally stored information typically includes non-financial data that is required to complete online transactions, such as a billing address or shipping address.

In some implementations, the mobile device 820 (e.g., electronic communication device 201) provides the Tap application 550 with a unique identifier 822, such as a MAC address, an MSISDN, an IMEI, an IMSI, phone number, email address, or IP address.

In some implementations, the Tap application 550 sends the unique identifier to a third party 826, such as a wireless carrier, and the third party provides (824) one or more authentication values corresponding to the unique identifier. The third party uses the unique identifier to look up an account corresponding to the device 820, and returns authentication values from the account information. For example, the authentication values may include a ZIP or postal code, an email address, or a user name.

Using all of the received information, including data retrieved from the proximity based chip card 808, data retrieved from local storage, data entered manually by the user 816, data received from the mobile device 820, and/or data received from one or more third parties 826, the application sends a transaction to an authentication party 830, such as a bank or other financial institution.

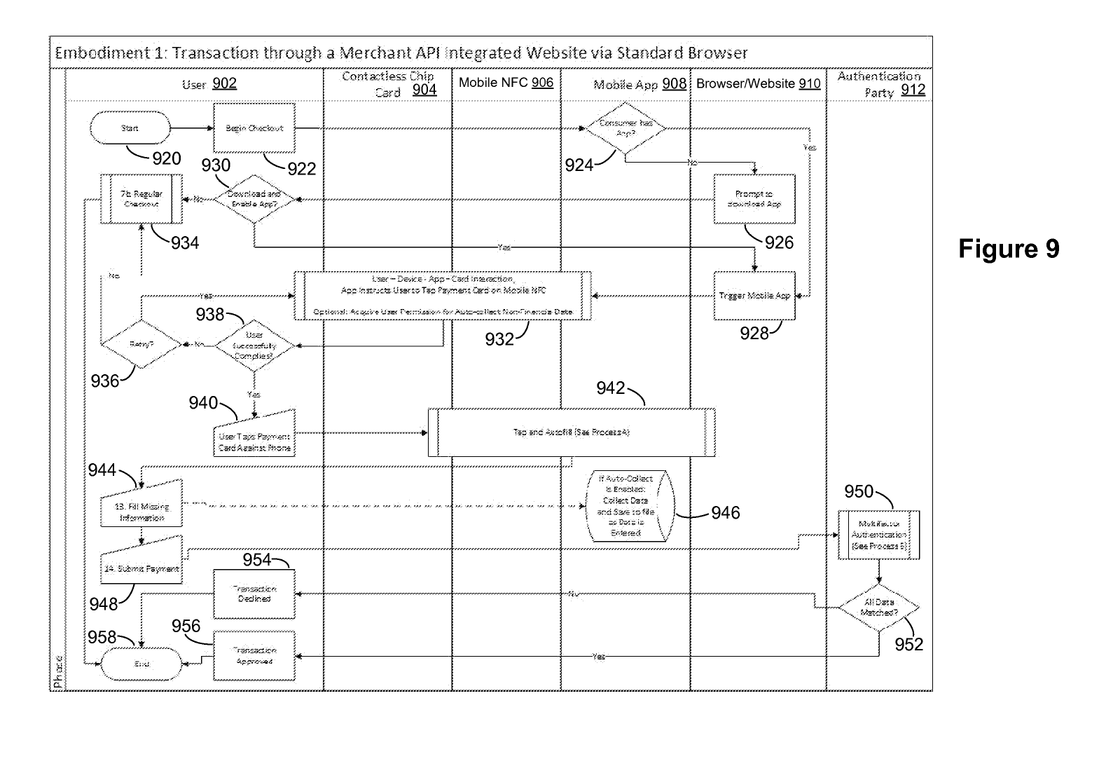

FIGS. 9-11 illustrate three implementations, which are labeled embodiments 1, 2, and 3.

FIG. 9 illustrates a transaction processed using a standard web browser 522 with a merchant's website that has an integrated API. The figure is broken into six columns to indicate the actions taken by different actors for completing the transaction. The first column 902 represents actions taken by the user. The second column 904 represents actions taken by the proximity based chip card. The third column 906 represents the actions of the near field communication (NFC) circuitry 554/software 528 on the mobile device 201. The fourth column 908 represents actions taken by a data collection application 550 on the mobile device 201. The fifth column 910 represents actions taken by the browser 522 in conjunction with the merchant's website. The sixth column 912 represents actions taken by an entity that performs authentication.

The user starts (920) the transaction. In this example, the user begins (922) a checkout at a merchant's website. In some implementations, the browser 522 determines (924) if the Tap application 550 is installed on the mobile device 201. If the Tap application is installed on the mobile device 201, the browser loads (928) and runs (928) the Tap application. If the Tap application is not installed, the browser prompts (926) the user to download the Tap application. In this case, when the Tap application is successfully downloaded (930), it is loaded (928) and executed (928). On the other hand, if the user chooses not to download the Tap application 550, the checkout process proceeds (934) in the “regular” unenhanced way and finishes (958).

The Tap application 550 then prompts (932) the user to tap a payment card against the mobile device 201. In some implementations, the Tap application 550 requests (932) permission to collect and store manually entered data for future use. The Tap application 550 determines (938) if the user has tapped (940) (i.e., brought into proximity) the payment card to the mobile device 201 to initiate extraction of data from the card. If the user does not, some implementations repeat (936) the prompt a small number of times (e.g., once or twice). After some predetermined number of unsuccessful retries, the checkout process is routed to the regular non-enhanced methodology.

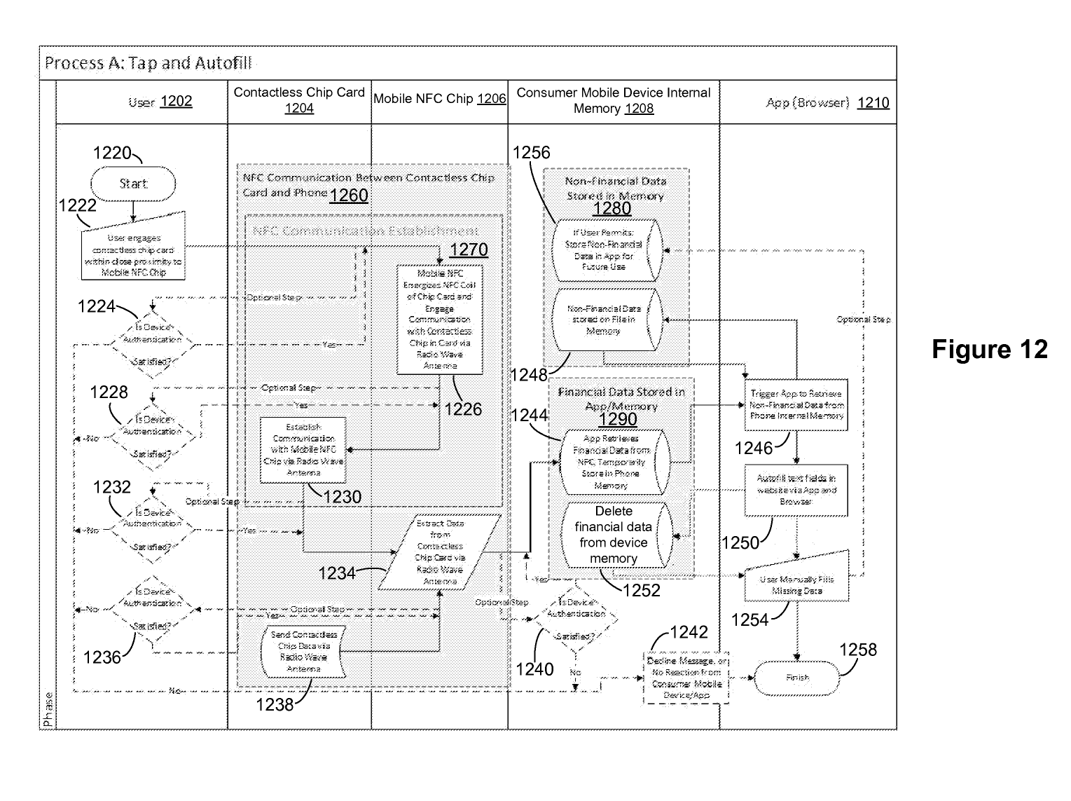

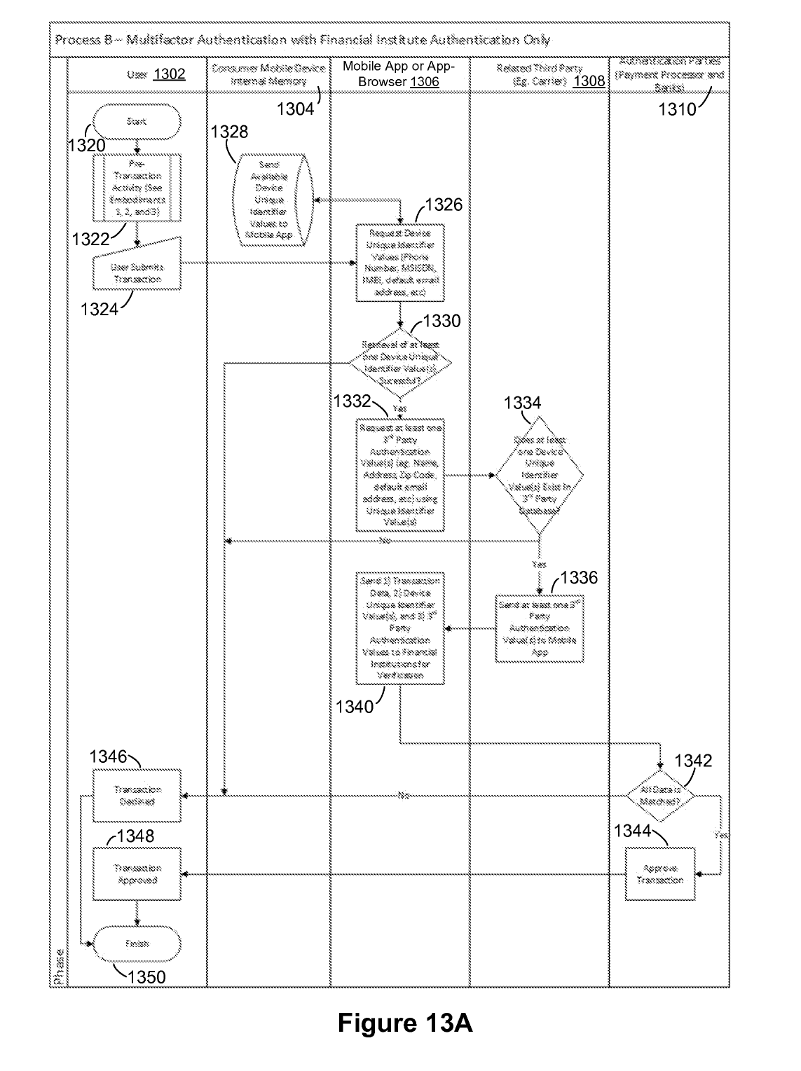

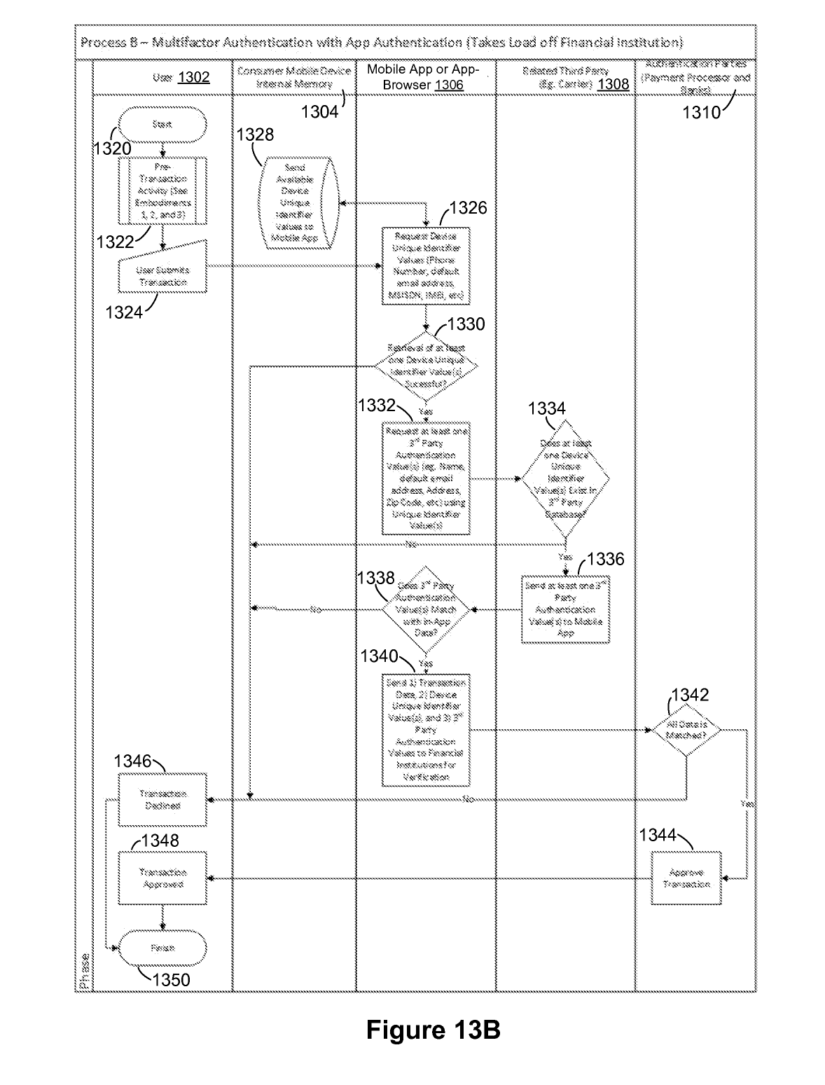

The tap and autofill process 942 is described in more detail below in FIG. 12. Whatever data entry fields are not filled by the tap process must be entered (944) manually, and the user submits (948) the transaction. In some implementations, one or more data entry fields cannot be edited by the user once they are filled by the Tap application/plugin 550. This can be used to guarantee authenticity (e.g., the data has not been manipulated) of the data retrieved by the Tap application/plugin 550. In some implementations, the submission of the transaction is automated after the data entry fields are filled and does not require manual submission by the user. In some implementations, when the Tap application 550 has permission from the user, the Tap application 550 collects and stores the information that the user manually enters. In some implementations, the authentication party (e.g., bank or credit card company) performs (950) multifactor authentication, as illustrated below in FIG. 13A or 13B. If the authentication process is successful (952), the transaction is approved (956). Otherwise, the transaction is declined (954). After the approval or declination, this portion of the process is complete (958). Subsequently, the product is shipped.

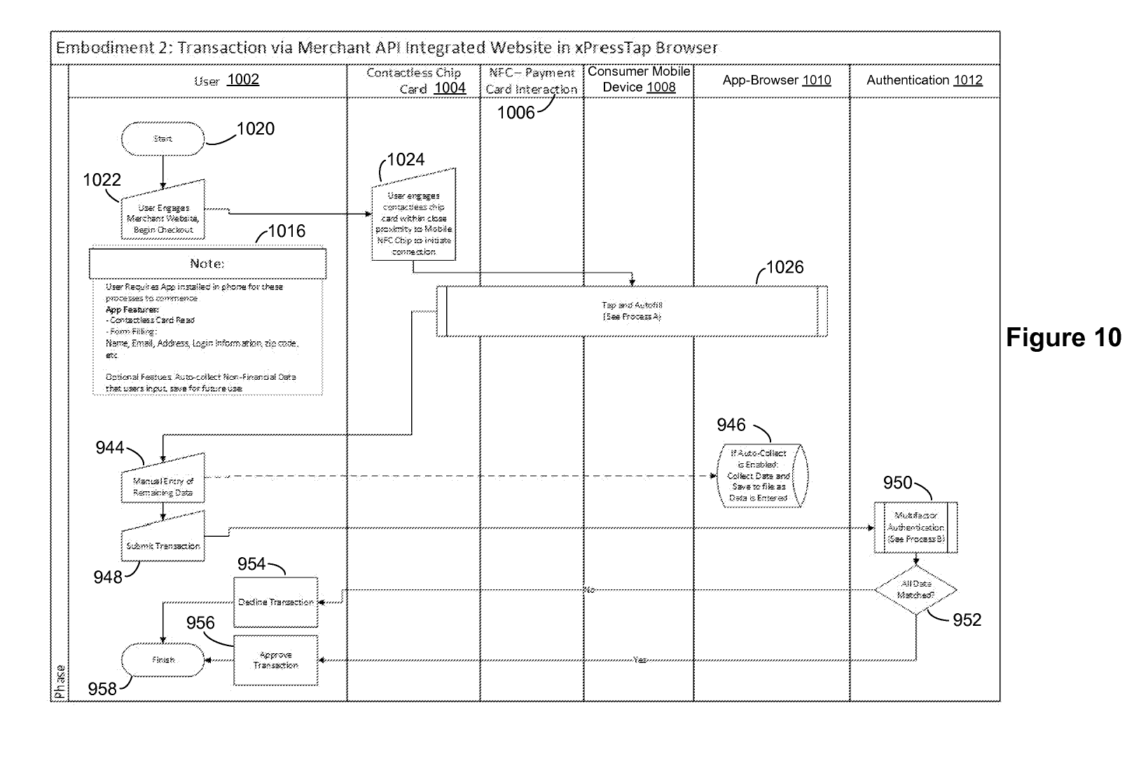

FIG. 10 is similar to FIG. 9, but illustrates the scenario where the user's browser 522 has been enhanced with the Tap functionality. In some implementations, the Tap functionality is implemented as a browser plugin. As in FIG. 9, the activities are subdivided into six columns, representing the user actions (1002), card actions (1004), actions of proximity based circuitry/software (1006) on the mobile device 201, actions of the mobile device (1008), actions of the tap-enhanced browser (1010), and authentication actions (1012).

As in FIG. 9, the user starts (1020) the transaction by beginning (1022) the checkout process at a merchant website. As noted in FIG. 10, the Tap application/plugin 550 must be installed in order for this process to begin. When installed, the Tap application/plugin can read a proximity based card and fill in financial and non-financial data without user input. The user energizes (1024) the proximity based chip card by bringing it into proximity with the proximity based communication circuitry 554 of the mobile device. In some implementations, the proximity required to energize the card is ten centimeters or less, but in other implementations, the required proximity is one or two inches. In some implementations, the required proximity is a configurable parameter that may be set for each mobile device 201. Tapping the card initiates (1026) the tap and autofill process described below in FIG. 12.

The remainder of FIG. 10 is as described above in FIG. 9, as indicated by the reference numbers 944-958. The user manually fills in any data that is not filled by the Tap application/plugin 550, the data is transmitted to an entity that performs authentication, and the transaction is approved or declined based on the authentication. In some implementations, one or more data entry fields cannot be edited by the user once they are filled by the Tap application/plugin 550. This can be used to guarantee authenticity (e.g., the data has not been manipulated) of the data retrieved by the Tap application/plugin 550.

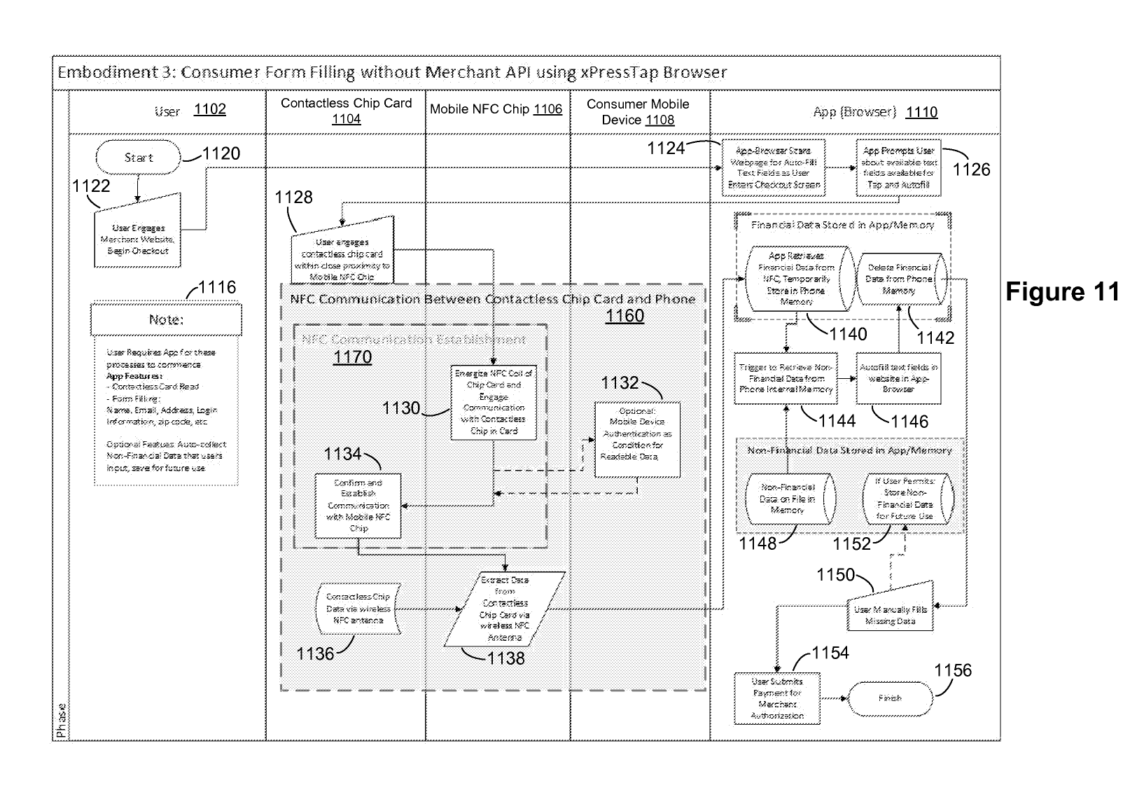

FIG. 11 illustrates the scenario where a merchant's website does not provide an API, but the user's browser 522 is enhanced with a disclosed Tap application/plugin 550. Here, the actions are subdivided into six columns based on what person or process performs the actions. The first column 1102 represents actions of the user and the second column 1104 represents actions of a proximity based chip card. The third column 1106 represents actions of the NFC circuitry 554 or software 528 on the user's mobile device 201, and the fourth column 1108 represents actions of the user's mobile device 201. The fifth column 1110 represents actions of the browser 522 and the Tap application plugin 550.

The user starts (1120) the process by initiating (1122) checkout on a merchant's website. Note that this scenario requires (1116) the Tap application/plugin 550 to already be installed. The Tap plugin 550 scans (1124) the checkout web page for text fields that can be filled, and prompts (1126) the user about the available fields. The user energizes (1128) the proximity based chip card by bringing it into close proximity with the NFC circuitry 554 of the mobile device 201. This begins communication between the proximity based chip card and the phone, as illustrated in the box 1160. In particular, the proximity energizes (1130) the chip card (e.g., the NFC coil) and begins communication. As part of establishing communication (1170), some implementations require authentication of the mobile device, which may be accomplished by providing a unique identifier of the device. The chip card confirms (1134) that communication has been established.

The NFC circuitry 554/software 528 then extracts (1138) data from the chip card using the wireless antenna 1136 of the card. The Tap application stores (1140) the extracted data, and, in some implementations, triggers (1144) retrieval of non-financial data (1148) from the phone's internal storage. The data, including both financial data and non-financial data, is used to fill in (1146) the text fields on the checkout web page. Once the data has filled the text fields, the temporary storage of financial data is deleted (1141). When there are text fields that could not be filled, they are filled (1150) by the user. In some implementations, one or more data entry fields cannot be edited by the user once they are filled by the Tap application/plugin 550. This can be used to guarantee authenticity (e.g., the data has not been manipulated) of the data retrieved by the Tap application/plugin 550. In some implementations, if the user allows saving of non-financial data, the Tap application stores (1152) any data that was manually entered by the user. Once all of the text fields have been filled, the user submits (1154) the payment for merchant authorization. In some implementations, the submission of the transaction is automated after the data entry fields are filled and does not require manual submission by the user. This completes (1156) the checkout portion that uses the Tap application 550.

At some merchant websites data is entered into multiple web pages sequentially. In that case, the Tap application 550 scans each web page as it is displayed and fills in the fields for which is has data, regardless of whether the data is financial or not.

Some implementations use a fourth alternative to extract data from a proximity based card. In this alternative, one or more web pages from the entity's website include executable script (e.g., Javascript), which requests a user's permission to activate the proximity based circuitry of a mobile computing device. When permission is given, the proximity based circuitry extracts data from the proximity based card when it is brought into proximity with the circuitry. The extracted data is then used to fill one or more data entry fields of the corresponding web page from the entity's website. This alternative simplifies the process for users because users can take advantage of simplified data entry without the requirement of downloading and installing a Tap application/plugin 550. The executable script received with the web page performs like the Tap application 550 described herein.

FIG. 12 illustrates a “tap and autofill” process similar to the process illustrated in FIG. 11. FIG. 12 is divided into five columns based on what actor is performing each of the actions. The first column 102 represents actions of the user, the second column 1204 represents actions of the proximity based chip card 1204, and the third column 1206 represents actions of the NFC circuitry 554/software 528 on the mobile device 201. The fourth column 1208 represents actions or data in the internal memory of the mobile device 201 and the fifth column 1210 represents actions of the Tap application 550 and/or the web browser 522.

At the start 1220 of this process, the user engages (1222) the proximity based chip card by bringing it into proximity of the NFC chip/circuitry 554 of the mobile device 201. In some implementations, the proximity based chip card determines (1224) whether the device is authenticated, and rejects communication if not authenticated. In some implementations, the proximity based chip card requires authentication of the user prior to initiating communication. User authentication can be implemented using a password or PIN, or using a biometric authentication device 556. This begins the communication (1260) between the proximity based chip and the mobile device 201, and initiates establishment of NFC communication (1270). The NFC circuitry energizes (1226) the chip card (e.g., NFC coil) and engages communication. Some implementations require device and/or user authentication (1228) at this stage in addition to, or instead of, requiring authentication earlier. This establishes communication between the proximity based chip card and the NFC circuitry of the mobile device using a radio wave antenna. Some implementations require (1232) device and/or user authentication again.

The NFC circuitry 554 then extracts (1234) data from the proximity based chip card, which is sent (1238) by the card. In some implementations, this involves device and/or user authentication (1236). The extracted data is stored (1244) temporarily by the Tap application 550 in the memory of the mobile device 201. As illustrated here, non-financial data 1280 is typically stored separately from the financial data 1290. In particular, the financial data is typically stored only briefly before being deleted (1252).

In some implementations, the retrieval of information from the card triggers retrieval (1248) of some non-financial data stored in memory. Using both the data extracted from the card and the data retrieved from memory, the application 550 fills (1250) text fields in the displayed web page. In some implementations, one or more data entry fields cannot be edited by the user once they are filled by the Tap application/plugin 550. This can be used to guarantee authenticity (e.g., the data has not been manipulated) of the data retrieved by the Tap application/plugin 550. Whatever text fields are not filled are entered manually (1254) by the user. When the user permits storage of user data, the application 550 stores (1256) the data in memory for future use. After the text fields are filled, the “tap and autofill” process is complete (1258), and the larger process shown in FIG. 9 or 10 continues. The tap and autofill process shown in FIG. 12 corresponds to the box 942 in FIG. 9 and the box 1026 in FIG. 10. In some implementations, if any of the device authentication steps fail, the user is alerted (1242) of the problem.

FIGS. 13A and 13B illustrate two processes that may be used for multi-factor authentication. These figures are subdivided into five columns based on which actor is performing each of the actions. The first column 1302 represents actions of the user, the second column 1304 represents actions within the memory of the mobile device 201, the third column 1306 represents actions of the Tap application 550 and/or web browser 522, the fourth column 1308 represents actions of a third party, and the fifth column 1310 represents actions of an authentication party.

The user initiates (1320) a transaction, and subsequent activity to fill in data occurs (1322) as described above with respect to FIG. 9, 10, or 11. The user then submits (1324) the transaction for processing. In some implementations, the submission of the transaction is automated after the data entry fields are filled and does not require manual submission by the user. The Tap application 550 requests (1326) a unique identifier for the device, which is retrieved (1328) from memory. As noted above, the unique identifier can take many forms. If the request for a unique identifier is not successful (1330), the transaction is declined (1346), and the process is done (1350) without completing the desired transaction.

Typically, however, a unique device identifier is received, and the Tap application 550 requests (1332) one or more authentication values from a third party based on the unique device identifier. In some implementations, the third party is a wireless phone carrier, and by providing the carrier a unique identifier for the mobile device, the carrier provides one or more authentication values associated with a corresponding wireless account. For example, the authentication values can include a name, an address, a postal code, or an email address. The third party authenticator (e.g., wireless carrier) determines (1334) if the unique identifier of the mobile device is valid. For example, the third party can check whether the unique identifier is in a database maintained by the third party. If the authentication value is not valid, the transaction is declined (1346), and the transaction is terminated (1350) unsuccessfully. If the unique identifier is valid, the third party returns (1336) at least one authentication value (e.g., a ZIP code) to the Tap application.

The Tap application 550 then sends (1340) data to a financial institution for processing. The transaction data typically includes (1340) transaction data, the unique identifier of the device, and the one or more authentication values returned by the third party. The financial institution or other authenticator determines (1342) if all of the data matches. If so, the transaction is approved (1344/1348), and the user's transaction completes (1350) successfully. On the other hand, if any of the data does not match, the transaction is declined (1346), and the transaction finishes (1350) unsuccessfully.

FIG. 13B is the same as FIG. 13A, except that there is an additional validation step 1338 performed by the Tap application 550, which reduces the likelihood of transmitting an invalid transaction to the financial institution.

In some implementations, the verification steps 1340-1344 are omitted. Once the authentication value(s) are retrieved from the third party, the transaction is read for processing, and is submitted for processing.

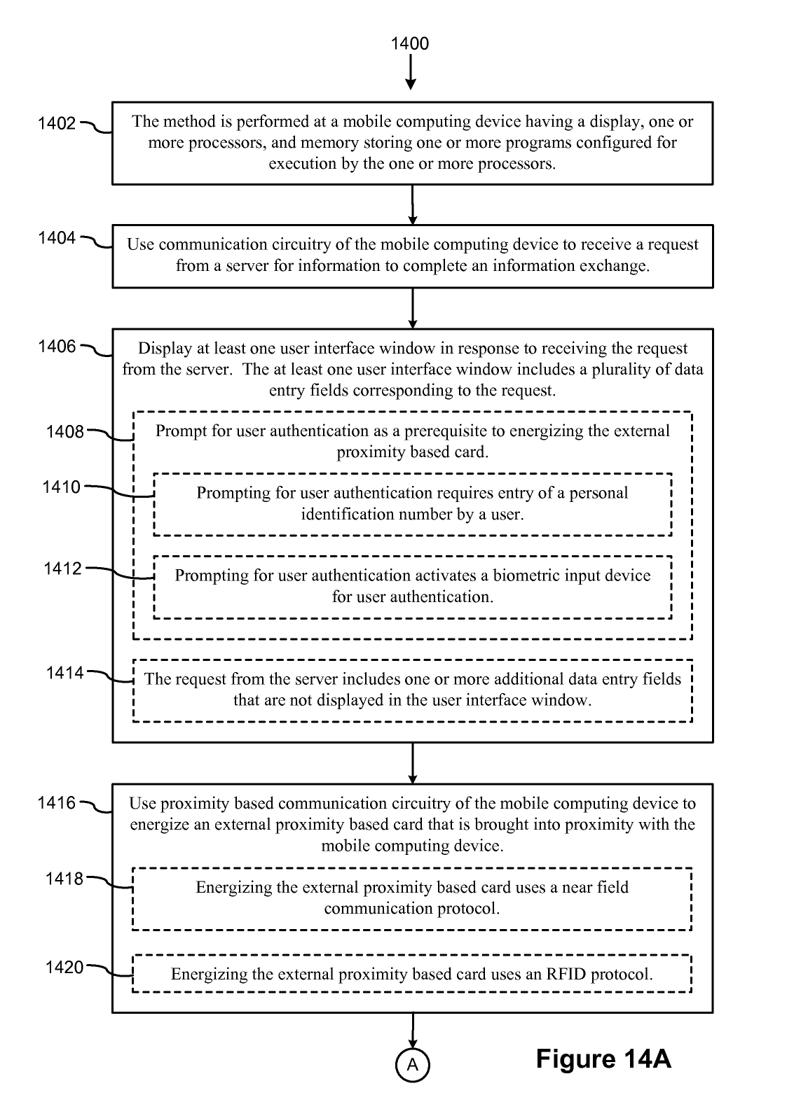

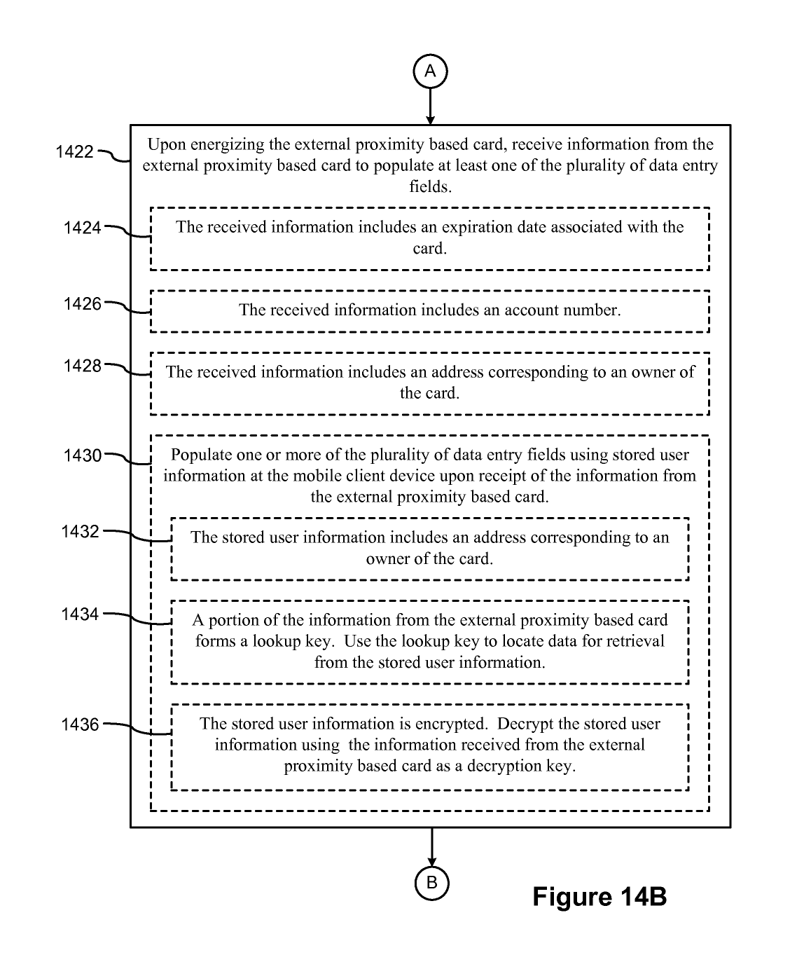

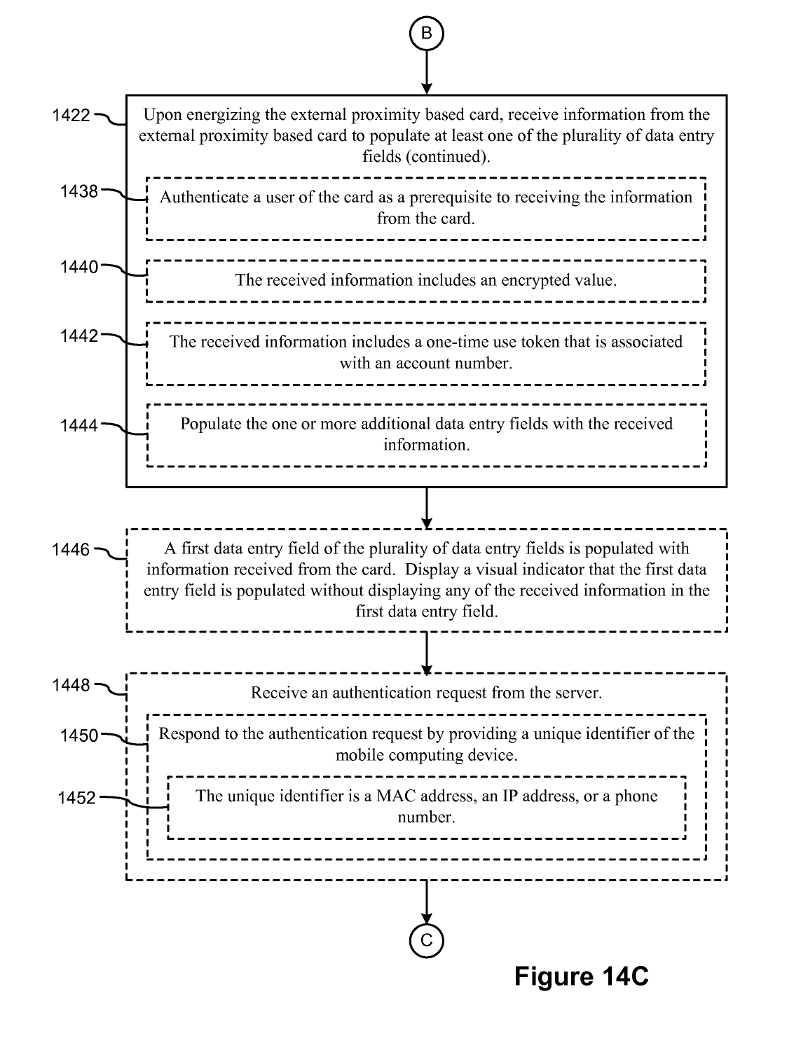

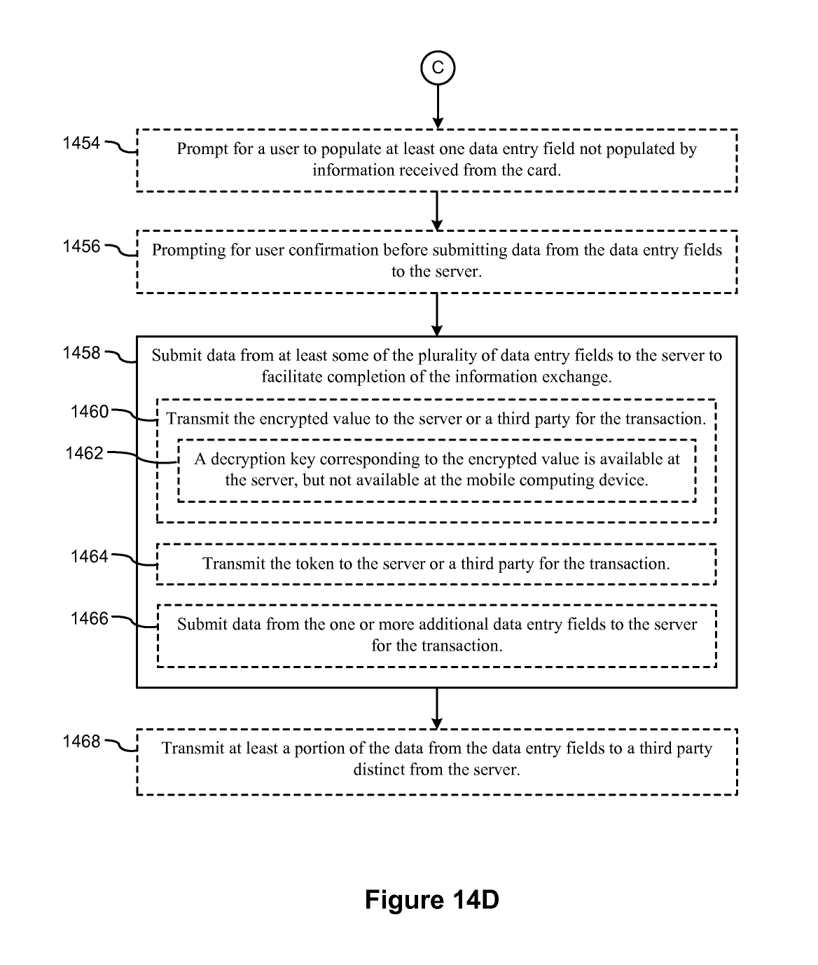

FIGS. 14A-14D provide a flowchart of a process 1400, performed (1402) by a mobile computing device having a display, one or more processors, and memory storing one or more programs configured for execution by the one or more processors. The process 1400 uses (1404) communication circuitry (e.g., communication interfaces 504) of the mobile computing device 201 to receive a request from a server for information to complete an information exchange. For example, the request may occur when a user visits a merchant's website and initiates checkout to purchase goods or services from the merchant. This is illustrated above in FIGS. 1, 4, 9, 10, and 11.

The mobile computing device 201 displays (406) at least one user interface window in response to receiving the request from the server. The at least one user interface window includes (1406) a plurality of data entry fields corresponding to the request. In some implementations, the process prompts (1408) for user authentication as a prerequisite to energizing an external proximity based card, as described below. Such an authentication process helps to prevent fraud because an unauthorized user of the card would not be authenticated, and thus not able to gain access to the stored information on the card. In some implementations, prompting for user authentication requires (1410) entry of a personal identification number or password by a user. In some implementations, prompting for user authentication activates (1412) a biometric input device 556 for user authentication. Some implementations use a combination of factors for user authentication.

In some implementations, the request from the server includes (1414) one or more additional data entry fields that are not displayed in the user interface window. For example, an additional undisplayed data entry field may be used to enter a unique identifier on the mobile device 201. In some implementations, the additional data entry fields include an account number, a social security number, a medical record number, or other sensitive personal information. These additional fields can be filled in using the disclosed process, but because these are not displayed, there is less risk of compromising the data due to another person nearby, such as a person shoulder surfing.

The process 1400 uses (1416) proximity based communication circuitry of the mobile computing device to energize an external proximity based card that is brought into proximity with the mobile computing device. This is illustrated above in FIG. 11 (e.g., box 1130) and FIG. 12 (e.g., box 1226). In some implementations, energizing the external proximity based card uses (1418) a near field communication (NFC) protocol. In some implementations, energizing the external proximity based card uses (1420) an RFID protocol.

Upon energizing the external proximity based card, the process 1400 receives (1422) information from the external proximity based card to populate at least one of the plurality of data entry fields. In some implementations, the received information includes (1424) an expiration date associated with the card. In some implementations, the received information includes (1426) an account number. In some implementations, the received information includes (1428) an address corresponding to an owner of the card. In some implementations, the information received from the card includes only financial information. In some implementations, the information received includes only non-financial information. In some implementations, the received information includes both financial and non-financial information.

In some implementations, the process 1400 populates (1430) one or more of the plurality of data entry fields using stored user information at the mobile client device upon receipt of the information from the external proximity based card. That is, in addition to the data received from the card, some implementations also retrieve information stored locally on the mobile device 201. The populated fields may include displayed data entry fields and/or non-displayed data entry fields. In some implementations, the stored user information includes (1432) an address corresponding to an owner of the card. In some implementations, a portion of the information from the external proximity based card forms (1434) a lookup key. The process 1400 uses (1434) the lookup key to locate data for retrieval from the stored user information. For example, a user may have two or more cards, each with corresponding distinct locally stored information. Some of the data from the card (e.g., the last four digits of an account number or a checksum) are used to look up the corresponding locally stored information. In some implementations, the local storage includes some data that is tied to a specific card as well as data that is associated with a user, regardless of what card is used. Some implementations also store device-specific information, which does not depend on which user is using the device 201.

In some implementations, the stored user information is (1436) encrypted. The process 1400 decrypts (1436) the stored user information using the information received from the external proximity based card as a decryption key. In some implementations, only a portion of the locally stored information is encrypted. In some implementations, only non-sensitive data is stored locally, and is stored in plaintext.

In some implementations, the process 1400 authenticates (1438) a user of the card as a prerequisite to receiving the information from the card. This can prevent the card from be used fraudulently if it is lost or stolen. In some implementations, the received information includes (1440) one or more encrypted values. In some instances, the mobile device 201 does not have a decryption key corresponding to a received encrypted value. However, a subsequent recipient of the transaction data (e.g., a financial institution) may have the decryption key and thus be able to access the data. In this way, sensitive information can be passed along while reducing the risk of compromising the data. Some implementations address security of sensitive data by using single-use tokens. For example, in some implementations, the received information includes (1442) a one-time use token that is associated with an account number. In some implementations, a card stores a set of single use tokens, and a different such token is used each time data is retrieved. In some implementations, circuitry in the card generates single-use tokens as needed.

When the request from the server includes additional data entry fields that are not displayed, some implementations populate (1444) one or more of these additional data entry fields with the received information.

As an alternative to completely hiding some data entry fields, some implementations provide an indicator in the display. For example, in some implementations, a first data entry field of the plurality of data entry fields is populated (1446) with information received from the card. The process 1400 displays a visual indicator that the first data entry field is populated without displaying any of the received information in the first data entry field. In some implementations, the indicator is one or more asterisks that replace the actual data. In some implementations, there is an indicator icon adjacent to data entry field (e.g., a check box), which has distinct visual appearances when the field is populated or not (e.g., checked or unchecked). In some implementations, the indicator use color coding.

In some implementations, the server issues a separate authentication request to identify the mobile device 201. In this case, the mobile device receives (1448) the authentication request from the server. In response to the authentication request, the mobile device provides (1450) a unique identifier of the device. In some implementations, the unique identifier is (1452) a MAC address, an IP address, a phone number of the device, an email address, a MSISDN number, an IMEI or MEID number, or an IMSI number.

In some instances, not all of the data entry fields are populated based on information received from the card or from locally stored information. If additional information is required to complete the information exchange or transaction, the process prompts (1454) the user to populate at least one data entry field not populated by information received from the card. In some implementations, when a user is required to manually enter some data, the user is given the opportunity to save the manually entered information for future use (e.g., for auto populating fields in the future).

Typically, implementations prompt (1456) for user confirmation before submitting data from the data entry fields to the server.

The data entry fields are thus populated based on data from the proximity based card, data stored locally on the device 201, and data entered manually by the user. Using this data, the process 1400 submits (1458) the data from at least some of the plurality of data entry fields to the server to facilitate completion of the information exchange. In some implementations where encrypted values are extracted from the card, the process 1400 transmits (1460) the encrypted values to the server or a third party for the transaction. In some implementations, a decryption key corresponding to the encrypted values is (1462) available at the server, but not available at the mobile computing device 201.

In some implementations where a single-use token is received from the card, the process 1400 transmits (1464) the token to the server or a third party for the transaction. The server or third party is able to use the token to access relevant data, such as an account number.

When the server provides additional data entry fields that are not displayed, implementations typically fill in those additional fields and submit (1466) data from the one or more additional data entry fields to the server for the transaction.

For some transactions or data exchanges there are additional third parties who need some of the information. For example, for a transaction that involves the purchase of goods, some of the information may be sent to a carrier who will deliver the goods. In these cases, the process 1400 transmits (1468) at least a portion of the data from the data entry fields to a third party distinct from the server.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations described herein were chosen and described in order to best explain the principles of the invention and its practical applications, to thereby enable others skilled in the art to best utilize the invention and various implementations with various modifications as are suited to the particular use contemplated.

What is claimed is:

1. A mobile computing device with proximity based communication circuitry, comprising:
one or more processors;
memory;
voice communication circuitry configured for facilitating a telephone call;
communication circuitry configured to receive a request from a server for information to complete an information exchange;
a display device configured to display at least one user interface window in response to receiving the request from the server, wherein the at least one user interface window includes a plurality of data entry fields corresponding to the request;
proximity based communication circuitry configured to:
energize an external proximity based card that is brought into proximity with the mobile computing device; and
upon energizing the external proximity based card, receive information from the external proximity based card to populate at least one of the plurality of data entry fields, wherein the communication circuitry is further configured to submit data from at least some of the plurality of data entry fields to the server to facilitate completion of the information exchange.

2. The mobile computing device of claim 1, wherein the proximity based communication circuitry uses a near field communication protocol.

3. The mobile computing device of claim 1, wherein the proximity based communication circuitry uses an RFID protocol.

4. The mobile computing device of claim 1, wherein the at least one user interface window further includes a prompt for user authentication as a prerequisite to energizing the external proximity based card.

5. The mobile computing device of claim 4, wherein the prompt for user authentication requires entry of a personal identification number by a user.

6. The mobile computing device of claim 4, wherein the prompt for user authentication activates a biometric input device for user authentication.

7. The mobile computing device of claim 1, wherein the at least one user interface window further includes a prompt for user confirmation before submitting data from the data entry fields to the server.

8. The mobile computing device of claim 1, wherein the at least one user interface window further comprises a prompt for a user to populate at least one data entry field not populated by information received from the card.

9. The mobile computing device of claim 1, wherein the received information includes an expiration date associated with the card.

10. The mobile computing device of claim 1, wherein the received information includes an account number.

11. The mobile computing device of claim 1, wherein the received information includes an address corresponding to an owner of the card.

12. The mobile computing device of claim 1, further comprising a database including stored user information used to populate one or more of the plurality of data entry fields upon receipt of the information from the external proximity based card.

13. The mobile computing device of claim 12, wherein the stored user information includes an address corresponding to an owner of the card.

14. The mobile computing device of claim 12, wherein a portion of the information from the external proximity based card forms a lookup key and the database is configured to use the lookup key to locate data for retrieval from the stored user information.

15. The mobile computing device of claim 12, wherein at least some of the stored user information is encrypted, and the mobile computing device further comprises a decryption module configured to decrypt the stored user information using the information received from the external proximity based card as a decryption key.

16. The mobile computing device of claim 1, wherein the memory includes instructions to authenticate a user of the card as a prerequisite to receiving the information from the card.

17. The mobile computing device of claim 1, further comprising a device authentication module configured to receive an authentication request from the server and to respond to the authentication request by providing a unique identifier of the mobile computing device.

18. The mobile computing device of claim 17, wherein the unique identifier is a MAC address, an IP address, or a phone number.

19. The mobile computing device of claim 1, wherein the communication circuitry is further configured to transmit at least a portion of the data from the data entry fields to a third party distinct from the server.

20. The mobile computing device of claim 1, wherein the received information includes an encrypted value and the encrypted value is transmitted to the server or a third party for the transaction.

21. The mobile computing device of claim 20, wherein a decryption key corresponding to the encrypted value is available at the server, but not available at the mobile computing device.

22. The mobile computing device of claim 1, wherein the received information includes a one-time use token that is associated with an account number, and the submission module is configured to transmit the token to the server or a third party for the transaction.

23. The mobile computing device of claim 1, wherein a first data entry field of the plurality of data entry fields is populated with information received from the card and the first data entry field includes a visual indicator that the first data entry field is populated without displaying any of the received information in the first data entry field.

24. The mobile computing device of claim 1, wherein the request from the server includes one or more additional data entry fields that are not displayed in the user interface window, the proximity based communication circuitry is configured to populate the one or more additional data entry fields with the received information, and the submission module is configured to submit data from the one or more additional data entry fields to the server for the transaction.
